(19) United States
(12) Patent Application Publication
(10) Pub. No.: US 2012/0308838 A1
(43) Pub. Date: Dec. 6, 2012

(54) PHOTOCURABLE RESIN COMPOSITION, DRY FILM, CURED ARTICLE AND PRINTED WIRING BOARD

(75) Inventors: Nobuhito Ito, Hiki-gun (JP); Daichi Okamoto, Hiki-gun (JP); Takahiro Yoshida, Hiki-gun (JP); Masao Arima, Hiki-gun (JP)

(73) Assignee: TAIYO HOLDINGS CO., LTD., Tokyo (JP)

(21) Appl. No.: 13/577,590

(22) PCT Filed: Feb. 2, 2011
(86) PCT No.: PCT/JP11/00568

§ 371 Date: Aug. 7, 2012

(30) Foreign Application Priority Data
Feb. 8, 2010 (JP) 2010-025485

(51) Int. Cl. C09D 133/08; C08K 5/5419; B32B 37/26; C09D 163/04; B05D 7/00; B32B 9/04; C09D 163/10

(52) U.S. Cl. 428/446; 522/39; 522/77; 427/385.5; 156/275.5

(57) ABSTRACT

Disclosed are: a photocurable resin composition which may be developed with an alkali, has excellent resolution properties, and enables a cured article having excellent (humidity) heat resistance and thermal impact resistance to be formed; a dry film; a cured article thereof; and a printed wiring board using the cured article. The photocurable resin composition of the present invention is characterized by containing a carboxyl group-containing resin, a photopolymerization initiator, and surface-treated Neuburg siliceous earth particles.

### TECHNICAL FIELD

The present invention relates to a photocurable resin composition used in, for example, a solder resist and the like; a dry film; a cured article thereof; and a printed wiring board using the cured article.

### BACKGROUND ART

Recently, in some printed wiring boards for consumer use or most of the solder resists of printed wiring boards for industrial use, from the viewpoint of high precision and high density, liquid development type solder resists, which are UV-light irradiated and then developed to form images, and cured finally (primary curing) by heat and/or photo-irradiation, have been used. Further, recently, in correspondence to high density of printed wiring boards accompanied by the production of light, slim, short and small electronic devices, improvement of workability or high performance of solder resists has been required.

On one hand, in consideration of environmental issues, alkali development type photosolder resists using an alkaline aqueous solution as a developer have been most commonly used. As these alkali development type photosolder resists, modified epoxy acrylate resins derived by modification of epoxy resins have been generally used.

For example, Patent Literature 1 reports a solder resist composition consisting of a photosensitive resin obtained by adding an acid anhydride to a reaction product of a novolac type epoxy compound and an unsaturated monobasic acid, a photopolymerization initiator, a diluent and an epoxy compound. In addition, Patent Literature 2 discloses a solder resist composition consisting of a photosensitive resin obtained by adding (meth)acrylic acid to an epoxy resin obtained by reacting epichlorohydrin with a reaction product of salicylaldehyde and a monovalent phenol and also reacting the mixture with a polybasic carboxylic acid or an anhydride thereof, a photopolymerization initiator, an organic solvent and the like.

However, it cannot be said that current alkali development type photosolder resists are sufficient in terms of durability such as alkali resistance, water resistance, heat resistance and the like, compared to thermosetting and solvent development type photosolder resists in the related art. This is thought to be the fact that an alkali development type photosolder resist includes a component having a hydrophilic group as a main component in order to enable the photosolder resist to be developed with an alkali, and intends to reduce chemical resistance such as alkali resistance and the like or adhesion between a resist film and copper in that a chemical solution, water, water vapor and the like easily permeate.

In particular, wet heat resistance is required for semiconductor packages such as a ball grid array (BGA), a chip scale package (CSP) and the like. However, in the current situation, wet heat resistance lasts only for several to several decade hours in a pressure cooker test (PCT) performed at high humidity and high temperature. Further, in a highly accelerated stress test (HAST) performed by applying voltage under conditions of high temperature and humidity, in most cases, defects caused by generation of migration over several hours are confirmed.

In addition, the attainable temperature in and out of the package is significantly increased, accompanied by shift to surface mounting, use of lead-free solders resulting from consideration of environmental issues and the like. Moreover, there are problems in that a coating film is deteriorated or characteristics thereof are changed by thermal hysteresis, and peeling-off is generated or PCT resistance or HAST resistance is deteriorated.

Further, there are problems in that the difference in coefficients of thermal expansion (CTE) between a solder resist and a substrate-forming material such as copper, a silicon chip, a substrate, an underfill and the like is large and cracks are generated in the resist in a thermal cycle test (TCT). On the contrary, it is possible to reduce the CTE by highly filling the solder resist with barium sulfate or crushed silica, or an inorganic filler such as molten silica and the like. However, on one hand, there is a problem in that it is difficult to achieve the high filling in that these inorganic fillers suppress photo reactions and deteriorate resolution properties.

### CITATION LIST

### Patent Literature

PLT 1: Japanese Patent Application Laid-Open No. 61-243869 (Claims)
PLT 2: Japanese Patent Application Laid-Open No. 3-250012 (Claims)

### SUMMARY OF THE INVENTION

### Technical Problem

The present invention has been made in consideration of these problems in the related art and provides a photocurable resin composition which may be developed with an alkali, has excellent resolution properties, and enables a cured article having excellent (humidity) heat resistance and thermal impact resistance to be formed, a dry film, a cured article thereof and a printed wiring board using the cured article.

### Solution to Problem

A photocurable resin composition of an aspect of the present invention is characterized by containing a carboxyl group-containing resin, a photopolymerization initiator, and Neuburg siliceous earth particles. By this configuration, it is possible to form a cured article which may be developed with an alkali, has excellent resolution properties, and has excellent (humidity) heat resistance and thermal impact resistance.

In the photocurable resin composition of an aspect of the present invention, Neuburg siliceous earth particles are preferably surfaced-treated. The surface treatment may be performed, thereby improving the wettability with the resin.

Further, in the photocurable resin composition of an aspect of the present invention, a silane coupling agent is also preferably contained. The silane coupling agent may be contained, thereby improving the wettability with the resin.

A dry film of an aspect of the present invention is characterized by including a dry coating film obtained by applying the photocurable resin composition having the above-described configuration on a film and drying the composition. By this configuration, it is possible to form a cured article which may be developed with an alkali, has excellent resolution properties, and has excellent (humidity) heat resistance and thermal impact resistance.

Further, the cured article of an aspect of the present invention is characterized by being obtained by applying the photocurable resin composition having the above-described configuration on a substrate or attaching the dry film having the above-described configuration to the substrate, and then followed by curing with irradiation of an active energy ray. By the configuration, it is possible to obtain (humidity) heat resistance and thermal impact resistance.

In addition, a printed wiring board of an aspect of the present invention is characterized by including the cured article. By the configuration, it is possible to have (humidity) heat resistance and thermal impact resistance and suppress deterioration and modification by heat hysteresis.

### ADVANTAGEOUS EFFECTS OF INVENTION

According to an aspect of the present invention, it is possible to obtain a photocurable resin composition which may be developed with an alkali, has excellent resolution properties, and enables a cured article having excellent (humidity) heat resistance and thermal impact resistance to be formed, a dry film, a cured article thereof, and a printed wiring board using the cured article.

### DESCRIPTION OF EMBODIMENTS

Hereinafter, embodiments of the present invention will be described in detail.

A photocurable resin composition of an embodiment of the present invention is characterized by containing a carboxyl group-containing resin, a photopolymerization initiator, and Neuburg siliceous earth particles.

Herein, as the carboxyl group-containing resin, known resins including a carboxyl group may be used. Among them, carboxyl group-containing resins which do not use an epoxy resin as a starting raw material are preferably used. The carboxyl group-containing resin has a very low content of halide ions, and may suppress the deterioration in insulation reliability. In particular, carboxyl group-containing photosensitive resins having an ethylenically unsaturated double bond in the molecule thereof are preferred from the viewpoint of photocurability or resistance to development. Further, the unsaturated double bond is preferably a double bond derived from acrylic acid or methacrylic acid, or derivatives thereof. In addition, when using only a carboxyl group-containing resin which does not have an ethylenically unsaturated double bond, a compound (photosensitive monomer) having one or more ethylenically unsaturated groups in the molecule thereof as described below needs to be used in combination in order to make the compound photocurable.

Specific examples of the carboxyl group-containing resin which may be used in the exemplary embodiment include the compounds (may be any one of oligomers and polymers) as hereinafter enumerated.

(1) A carboxyl group-containing photosensitive resin obtained by reacting (meth)acrylic acid with a difunctional or polyfunctional (solid) epoxy resin as described below and adding a dibasic acid anhydride such as anhydrous phthalic acid, tetrahydro anhydrous phthalic acid, hexahydro anhydrous phthalic acid and the like to a hydroxyl group present in a side chain thereof.

(2) A carboxyl group-containing photosensitive resin obtained by reacting (meth)acrylic acid with a hydroxyl group of a difunctional (solid) epoxy resin as described below in a polyfunctional epoxy resin epoxidated with epichlorohydrin and adding a dibasic acid anhydride to a hydroxyl group produced.

(3) A carboxyl group-containing photosensitive resin obtained by reacting an unsaturated group-containing monocarboxylic acid such as (meth)acrylic acid and the like with a compound having at least one alcoholic hydroxyl group and one phenolic hydroxyl group in a molecule thereof in an epoxy compound having two or more epoxy groups in a molecule thereof and reacting a polybasic acid anhydride such as anhydrous maleic acid, tetrahydro anhydrous phthalic acid, anhydrous trimellitic acid, anhydrous pyromellitic acid, adipic acid and the like with an alcoholic hydroxyl group of a reaction product obtained.

(4) A carboxyl group-containing photosensitive resin obtained by reacting a polybasic acid anhydride with a reaction product obtained by reacting an unsaturated group-containing monocarboxylic acid such as (meth)acrylic acid and the like with a reaction product obtained by reacting alkylene oxide such as ethylene oxide, propylene oxide and the like with a compound having two or more phenolic hydroxyl groups in a molecule of bisphenol A, bisphenol F, bisphenol S, a novolac type phenol resin, poly-p-hydroxy styrene, a condensate of naphthol with aldehydes, a condensate of dihydroxy naphthalene with aldehydes and the like.

(5) A carboxyl group-containing photosensitive resin obtained by reacting a polybasic acid anhydride with a reaction product obtained by reacting an unsaturated group-containing monocarboxylic acid with a reaction product obtained by reacting a cyclic carbonate compound such as ethylene carbonate, propylene carbonate and the like with a compound having two or more phenolic hydroxyl groups in a molecule thereof.

(6) A terminal carboxyl group-containing urethane resin prepared by reacting an acid anhydride with an end of an urethane resin by polyaddition reaction of a diol compound such as a polycarbonate-based polyol, a polyether-based polyol, a polyester-based polyol, a polyolefin-based polyol, an acrylic polyol, a bisphenol A-based alkylene oxide adduct diol, a compound having a phenolic hydroxyl group and an alcoholic hydroxyl group and the like with a diisocyanate compound such as an aliphatic diisocyanate, a branched aliphatic diisocyanate, an alicylic diisocyanate, an aromatic diisocyanate and the like.

(7) A carboxyl group-containing urethane resin to which a compound having one hydroxyl group and one or more (meth)acryloyl groups in a molecule of hydroxy alkyl(meth)acrylate is added during the synthesis of a carboxyl group-containing urethane resin by polyaddition reaction of a diol compound with diisocyanate and a carboxyl group-containing dialcohol compound such as dimethylolpropionic acid, dimethylol butyric acid and the like, and which is terminally (meth)acrylated.

(8) A carboxyl group-containing urethane resin to which a compound having one isocyanate group and one or more (meth)acryloyl groups in a molecule thereof, such as a molar reactant of isophorone diisocyanate, pentaerythritol triacrylate and the like is added during the synthesis of a carboxyl group-containing urethane resin by polyaddition reaction of a diol compound with diisocyanate and a carboxyl group-containing dialcohol compound, and which is terminally (meth)acrylated.

(9) A carboxyl group-containing resin obtained by copolymerization of an unsaturated carboxyl acid such as (meth)acrylic acid and the like with an unsaturated group-containing compound such as styrene, α-methylstyrene, a lower alkyl(meth)acrylate, isobutylene and the like.

(10) A carboxyl group-containing photosensitive resin composed by reacting a dicarboxylic acid such as adipic acid, phthalic acid, hexa hydro phthalic acid and the like with a polyfunctional oxetane resin as described below and additionally adding a compound having one epoxy group and one or more (meth)acryloyl groups in a molecule such as glycidyl(meth)acrylate, α-methyl glycidyl(meth)acrylate and the like to a carboxyl group-containing polyester resin obtained by adding a dibasic acid anhydride to a primary hydroxyl group produced.

(11) A carboxyl group-containing photosensitive resin obtained by adding a compound having a cyclic ether group and a (meth)acryloyl group in a molecule thereof to the above-described carboxyl group-containing resin of (1) to (10).

Further, as used herein, the term (meth)acrylate collectively refers to acrylate, methacrylate and a mixture thereof, and the same applies to other similar expressions hereinafter.

Among these carboxyl group-containing resins, a carboxyl group-containing resin which does not use an epoxy resin as a starting raw material may be appropriately used as described above. Accordingly, among specific examples of the above-described carboxyl group-containing resin, (4) to (8) may be particularly appropriately used.

As described above, an epoxy resin may not be used as a starting raw material, thereby reducing the amount of chlorine ion impurities as low as, for example, 100 ppm or less. The content of chlorine ion impurities of the carboxyl group-containing resin appropriately used in the exemplary embodiment is from 0 ppm to 100 ppm, more preferably from 0 ppm to 50 ppm and even more preferably from 0 ppm to 30 ppm.

Further, an epoxy resin may not be used as a starting raw material, thereby readily obtaining a resin which does not include a hydroxyl group. In general, the presence of the hydroxyl group is allowed to have excellent characteristics such as improvement of adhesion by hydrogen bonding and the like, but is known to reduce humidity resistance significantly, and a hydroxyl group may not be included, thereby improving humidity resistance.

In addition, a carboxyl group-containing resin which does not include a hydroxyl group may obtain excellent PCT resistance when treated with or added by Neuburg siliceous earth particles and a silane coupling agent, compared to a carboxyl group-containing resin including a hydroxyl group in a large amount. This is thought to be the fact that in the case of a carboxyl group-containing resin including a hydroxyl group in a large amount, a silanol group of the silane coupling agent reacts with a hydroxyl group of a resin rather than a filler surface and thus intends not to effectively act on the bond between the filler and the resin. Furthermore, in another aspect, a carboxyl group-containing resin which does not include a hydroxyl group is stable for the silane coupling agent and may be effective even from the viewpoint of storage stability.

Specifically, it is possible to obtain a resin which does not have a hydroxyl group theoretically in a range of a double bond equivalent of from 300 to 550 and an acid value of from 40 mgKOH/g to 120 mgKOH/g by partially acrylating a phenol novolac resin which does not include chlorine ion impurities with an alkyl oxide-modified phenol resin and introducing an acid anhydride. Further, the phenol novolac resin which does not include chlorine ion impurities may be readily obtained.

On one hand, in a case where an epoxy acrylate-modified resin used in a general solder resist is used, when all of the epoxy groups of an epoxy resin synthesized from a similar phenol novolac resin are acrylated and an acid anhydride is introduced into all of the hydroxyl group, the acid value is excessively increased as a double bond equivalent of from 400 to 500, and thus a coating film having resistance to development may not be obtained even after exposure. Besides, water resistance is deteriorated in that the acid value is high, and insulation reliability and PCT resistance are significantly reduced. That is, it is very difficult to completely remove a hydroxyl group from an epoxy acrylate-based resin derived from a similar phenol novolac-type epoxy resin.

Further, a carboxyl group-containing urethane resin synthesized from an isocyanate compound which does not use phosgene as a starting raw material and a raw material which does not use epihalohydrin and including chlorine ion impurities in an amount of from 0 ppm to 30 ppm is also appropriately used. In the urethane resin, a resin which does not include a hydroxyl group may be readily synthesized by adding equivalents of a hydroxyl group and an isocyanate group.

In addition, an epoxy acrylate-modified raw material may be used as a diol compound during the synthesis of the urethane resin. It is possible to use the raw material in that chlorine ion impurities are incorporated but the amount of chlorine ion impurities may be controlled.

From this viewpoint, for example, in order to obtain a solder resist composition having better PCT resistance, HAST resistance and thermal impact resistance as a solder resist for a semiconductor package, the above-described carboxyl group-containing resins (4) to (8) may be more appropriately used.

In addition, for a carboxyl group-containing resin (9) obtained by copolymerization with an unsaturated group-containing compound previously described, a carboxyl group-containing photosensitive resin with which 3,4-epoxy cyclohexyl methylmethacrylate is reacted as a compound having a cyclic ether group and a (meth)acryloyl group in a molecule thereof may also be appropriately used because chlorine ion impurities are present in small amounts in that an alicyclic epoxy is used.

On one hand, when glycidyl methacrylate as a compound having a cyclic ether group or a (meth)acryloyl group in a molecule thereof is reacted with the carboxyl group-containing resin (9) or glycidyl methacrylate as an unsaturated group-containing compound is copolymerized with the carboxyl group-containing resin (9), there is a concern that the amount of chlorine ion impurities may be increased.

Because the carboxyl group-containing resin has a plurality of carboxyl groups in a side chain of a backbone polymer, it is possible to achieve development by an alkaline aqueous solution.

Furthermore, the carboxyl group-containing resin has an acid value of preferably from 40 mgKOH/g to 150 mgKOH/g. When the acid value of the carboxyl group-containing resin is less than 40 mgKOH/g, it is difficult to achieve alkali development. On one hand, when the value exceeds 150 mgKOH/g, dissolution of exposed parts by a developer proceeds, and thus the line is thinned more than is necessary. In some cases, dissolution and peeling-off is caused by a developer without generating any distinction between exposed parts and unexposed parts, and thus it is difficult to form a normal resist pattern. The value is more preferably from 0 mgKOH/g to 130 mgKOH/g.

Further, the weight average molecular weight of the carboxyl group-containing resin varies depending on the resin skeleton. However, in general, the weight average molecular weight is preferably from 2,000 to 150,000. When the weight average molecular weight is less than 2,000, tack-free performance may be deteriorated in some cases, and wet resistance of the coating film after exposure is deteriorated, and thus a film loss occurs during development and the resolution thereof is greatly deteriorated in some cases. On one hand, when the weight average molecular weight exceeds 150,000, developability is significantly deteriorated and storage stability is deteriorated in some cases. The weight average molecular weight is more preferably from 5,000 to 100,000.

The amount of the carboxyl group-containing resin blended is preferably from 20 mass % to 60 mass % based on the total composition. When the amount is less than 20 mass %, the strength of the coating film is reduced. On one hand, when the amount is more than mass %, the viscosity is increased and the applicability and the like are reduced. The amount is more preferably from 30 mass % to 50 mass %.

As the polymerization initiator used in the exemplary embodiment, an oxime ester-based photopolymerization initiator having an oxime ester group, an α-amino acetophenone-based photopolymerization initiator and an acyl phosphine oxide-based photopolymerization initiator may be used, and among them, at least one or more initiators are preferably used.

As the oxime ester-based photopolymerization initiator, examples of commercially available products include CGI-325, IRGACURE (registered trademark) OXE01 and IRGACURE OXE02 manufactured by Ciba Specialty Chemicals Inc., N-1919 and ADEKA ARKLS (registered trademark) NCI-831 manufactured by ADEKA CORPORATION and the like.

In addition, a photopolymerization initiator having two oxime ester groups in a molecule thereof may also be appropriately used, and specifically, oxime ester compounds having a carbazole structure represented by the following general formula may be included.

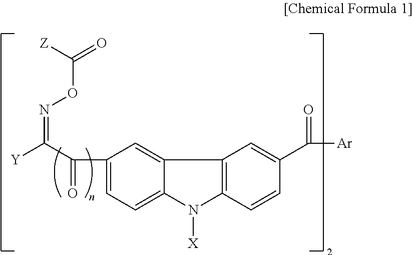

(In the formula, X represents a hydrogen atom, an alkyl group having from 1 to 17 carbon atoms, an alkoxy group having from 1 to 8 carbon atoms, a phenyl group, a phenyl group (substituted with an alkyl amino group or a dialkyl amino group having an alkyl group having from 1 to 17 carbon atoms, an alkoxy group having from 1 to 8 carbon atoms, an amino group and an alkyl group having from 1 to 8 carbon atoms), a naphthyl group (substituted with an alkyl amino group or a dialkyl amino group having an alkyl group having from 1 to 17 carbon atoms, an alkoxy group having from 1 to 8 carbon atoms, an amino group and an alkyl group having from 1 to 8 carbon atoms), each of Y and Z represents a hydrogen atom, an alkyl group having from 1 to 17 carbon atoms, an alkoxy group having from 1 to 8 carbon atoms, a halogen group, a phenyl group, a phenyl group (substituted with an alkyl amino group or a dialkyl amino group having an alkyl group having from 1 to 17 carbon atoms, an alkoxy group having from 1 to 8 carbon atoms, an amino group and an alkyl group having from 1 to 8 carbon atoms), a naphthyl group (substituted with an alkyl amino group or a dialkyl amino group having an alkyl group having from 1 to 17 carbon atoms, an alkoxy group having from 1 to 8 carbon atoms, an amino group and an alkyl group having from 1 to 8 carbon atoms), an anthryl group, a pyridyl group, a benzofuryl group and a benzothienyl group, Ar represents alkylene having from 1 to 10 carbon atoms, vinylene, phenylene, biphenylene, pyridylene, naphthylene, thiophene, anthrylene, thienylene, furylene, 2,5-pyrrole-diyl, 4,4′-stilbene-diyl, and 4,2′-styrene-diyl, and n represents an integer of 0 or 1).

In particular, in the formula, it is preferred that each of X and Y is a methyl group or an ethyl group, Z is methyl or phenyl, n is 0, and Ar is phenylene, naphthylene, thiophene or thienylene.

The amount of the oxime ester-based photopolymerization initiator blended is preferably from 0.01 part by mass to 5 parts by mass based on 100 parts by mass of the carboxyl group-containing resin. When the amount is less than 0.01 part by mass, the photocurability on copper is insufficient, the coating film is peeled off, and coating film characteristics such as chemical resistance and the like are deteriorated. On one hand, when the amount exceeds 5 parts by mass, the photoabsorption on the surface of the solder resist coating film becomes intense and the depth curability tends to be reduced. The amount is more preferably from 0.5 part by mass to 3 parts by mass.

Specific examples of the α-amino acetophenone-based photopolymerization initiator include
2-methyl-1-[4-(methylthio)phenyl]-2-morpholinopropanon-1,
2-benzyl-2-dimethylamino-1-(4-morpholinophenyl)-butan-1-one,
2-(dimethylamino)-2-[(4-methylphenyl)methyl]-1-[4-(4-morpholinyl)phenyl]-1-butanone,
N,N-dimethylamino acetophenone and the like. Examples of commercially available products thereof include IRGACURE 907, IRGACURE 369, IRGACURE 379 and the like manufactured by Ciba Specialty Chemicals Inc.

Specific examples of the acyl phosphine oxide-based photopolymerization initiator include 2,4,6-trimethylbenzoyl diphenylphosphine oxide, bis(2,4,6-trimethylbenzoyl)-phenylphosphine oxide, bis(2,6-dimethoxybenzoyl)-2,4,4-trimethyl-pentylphosphine oxide and the like. Examples of commercially available products thereof include Lucirin (registered trademark) TPO manufactured by BASF Corporation, IRGACURE 819 manufactured by Ciba Specialty Chemicals Inc. and the like.

The amount of the α-amino acetophenone-based photopolymerization initiator and the acyl phosphine oxide-based photopolymerization initiator blended is preferably from 0.01 part by mass to 15 parts by mass based on 100 parts by mass of the carboxyl group-containing resin. When the amount is less than 0.01 part by mass, likewise, the photocurability on copper is insufficient, the coating film is peeled off, and coating film characteristics such as chemical resistance and the like are deteriorated. On one hand, when the amount exceeds 15 parts by mass, an outgas reduction effect may not be obtained and photoabsorption on the surface of the solder resist coating film becomes intense, and thus the depth curability tends to be reduced. The amount is more preferably from 0.5 part by mass to 10 parts by mass.

Besides, examples of the photopolymerization initiator, the photoinitiation aid and the sensitizer which may be appropriately used in the photocurable resin composition of the exemplary embodiment include a benzoin compound, an acetophenone compound, an anthraquinone compound, a thioxanthone compound, a ketal compound, a benzophenone compound, a tertiary amine compound, a xanthone compound and the like.

Specific examples of the benzoin compound include benzoin, benzoin methyl ether, benzoin ethyl ether, benzoin isopropyl ether and the like.

Specific examples of the acetophenone compound include acetophenone, 2,2-dimethoxy-2-phenyl acetophenone, 2,2-diethoxy-2-phenylacetophenone, 1,1-dichloroacetophenone and the like.

Specific examples of the anthraquinone compound include 2-methylanthraquinone, 2-ethylanthraquinone, 2-t-butylanthraquinone, 1-chloroanthraquinone and the like.

Specific examples of the thioxanthone compound include 2,4-dimethylthioxanthone, 2,4-diethylthioxanthone, 2-chlorothioxanthone, 2,4-diisopropylthioxanthone and the like.

Specific examples of the ketal compound include acetophenone dimethyl ketal, benzyl dimethyl ketal and the like.

Specific examples of the benzophenone compound include benzophenone, 4-benzoyldiphenyl sulfide, 4-benzoyl-4′-methyldiphenyl sulfide, 4-benzoyl-4′-ethyldiphenyl sulfide, 4-benzoyl-4′-propyl diphenyl sulfide and the like.

Specific examples of the tertiary amine compound include an ethanolamine compound and a compound having a dialkylaminobenzene structure, and examples of commercially available products thereof include dialkylaminobenzophenone such as 4,4′-dimethylaminobenzophenone (Nisso Cure (registered trademark) MABP, manufactured by Nippon Soda Co., Ltd.), 4,4′-diethylaminobenzophenone (EAB, manufactured by HODOGAYA CHEMICAL CO., LTD.) and the like, a dialkylamino group-containing coumarin compound such as 7-(diethylamino)-4-methyl-2H-1-benzopyran-2-one (7-(diethylamino)-4-methylcoumarin) and the like, ethyl 4-dimethylamino benzoate (KAYACURE (registered trademark) EPA, manufactured by Nippon Kayaku Co., Ltd.), ethyl 2-dimethylamino benzoate (Quantacure DMB, manufactured by International Bio-synthetics Ltd.), (n-butoxy)ethyl 4-dimethylamino benzoate (Quantacure BEA, manufactured by International Bio-synthetics Ltd.), p-dimethylamino benzoic acid isoamylethyl ester (KAYACURE DMBI, manufactured by Nippon Kayaku Co., Ltd.), 2-ethylhexyl 4-dimethylamino benzoate (Esolol 507, manufactured by Van Dyk) and the like.

Among them, the thioxanthone compounds and the tertiary amine compounds are preferred. In particular, the depth curability may be improved by including the thioxanthone compound.

The amount of the thioxanthone compound blended is preferably 20 parts by mass or less based on 100 parts by mass of the carboxyl group-containing resin. When the amount of the thioxanthone compound blended exceeds 20 parts by mass, the film thickness curability is reduced and also a production cost increases. The amount is more preferably from 10 parts by mass or less.

Further, compounds having a dialkylaminobenzene structure are preferred as a tertiary amine compound. Among them, a dialkylaminobenzophenone compound, a dialkylamino group-containing coumarin compound with a maximum absorption wavelength in a range of from 350 nm to 450 nm and ketocoumarins are particularly preferred.

As a dialkylaminobenzophenone compound, 4,4′-diethylaminobenzophenone is preferred in that the compound has low toxicity. The dialkylamino group-containing coumarin compound has a maximum absorption wavelength of from 350 nm to 410 nm, which is within a UV range, and thus it is possible to obtain a less colored, colorless and transparent photosensitive composition and a colored solder resist film in which the color of a coloring pigment itself is reflected by using the coloring pigment.

In particular, 7-(diethylamino)-4-methyl-2H-1-benzopyran-2-one is preferred in that the compound shows an excellent sensitizing effect for laser light with a wavelength of from 400 nm to 410 nm.

The amount of the tertiary amine compound blended is preferably 0.1 part by mass to 20 parts by mass based on 100 parts by mass of the carboxyl group-containing resin. When the amount of the tertiary amine compound blended is less than 0.1 part by mass, it tends to be difficult to obtain a sufficient sensitizing effect. On one hand, when the amount exceeds 20 parts by mass, photoabsorption by a tertiary amine compound on the surface of a coating film becomes intense and depth curability tends to be decreased. The amount is more preferably from 0.1 part by mass to 10 parts by mass.

The photopolymerization initiator, photoinitiation aid and sensitizer may be used either alone or in combination of two or more thereof.

The total amount of the photopolymerization initiator, photoinitiation aid and sensitizer is preferably 35 parts by mass or less based on 100 parts by mass of the carboxyl group-containing resin. When the amount exceeds 35 parts by mass, depth curability tends to be reduced due to light absorption by the photopolymerization initiator, photoinitiation aid and sensitizer.

Further, for the photopolymerization initiator, photoinitiation aid and sensitizer to absorb light with a specific wavelength, sensitivity may be reduced in some cases and the photopolymerization initiator, photoinitiation aid and sensitizer may function as a UV absorbing agent in some cases. However, the photopolymerization initiator, photoinitiation aid and sensitizer are not used only for the purpose of improving the sensitivity of the composition. If necessary, it is also possible that, with absorption of light with a specific wavelength, photoreactivity on the surface thereof is increased, and a line shape of a resist and an aperture are changed into a vertical shape, a tapered shape, or a reverse tapered shape, and machining precision of a line width or an aperture diameter may be improved.

Neuburg siliceous earth particles used in the exemplary embodiment are natural combined substances called silitin and silicolloid, and have a structure in which spherical silica and a plate-shaped kaolinite are loosely combined with each other. By this structure, it is possible to impart excellent physical properties to a cured article, which may not be obtained in, for example, barium sulfate, or a filler such as crushed or molten silica and the like.

These Neuburg siliceous earth particles not only exhibit large effects on lowering the CTE of the cured article but also have a refractive index close to that of used resins (n=1.55), and thus it is possible to have improvement of physical properties and excellent resolution properties without reducing the resolution properties even though the particles are highly filled.

Further, in that Neuburg siliceous particles consist of silica and kaolinite, a silane coupling agent to be described below acts very effectively, and sufficient wettability may be obtained for resins.

In addition, barium sulfate or talc used as a filler in the related art has low affinity with a silanol group which is a reaction point of a silane coupling agent, and thus it is almost impossible to obtain the improvement of wettability or physical properties by silane coupling treatment. Further, silica may be reacted with a silanol group, and thus the effect of the silane coupling agent is sufficiently acknowledged. However, the refractive index thereof is 1.47, which is greatly different from the refractive index (from 1.52 to 1.59) of a photosensitive (a carboxyl group-containing) resin including a large amount of aromatic rings which are appropriately used for a highly reliable resist. Therefore, the high filling allows, for example, the aperture shape of the solder resist to cause halation and become a shape which greatly deviates from the designed value, and it is difficult to achieve the improvement of physical properties by the high filling.

The Neuburg siliceous earth particles may be readily obtained. However, the particles are a mineral and thus have a relatively large particle diameter. However, a smaller size diameter may be readily obtained by grinding the particles, and thus when the particles are used in an electronic material, the particles may be more appropriately used by using an appropriate particle diameter.

For example, when the particles are used as photocurable resin composition for a printed wiring board, which requires high reliability, it is preferred that the particle diameter is maintained at D₅₀=2.0 μm or less. In addition, in order to completely remove coarse particles, it is preferred that particles are dispersed and sorted again, or prepared into slurry by a disperser such as jet mill, bead mill and the like, and then separated by filtration and used. In this case, the maximum particle diameter is preferably 5.0 μm or less. By maintaining the maximum particle diameter at 5.0 μm or less, for example, when the particles are used as a solder resist, the resolution properties are excellent and protrusions of particles are not confirmed from the side of the aperture, and thus very clean particles may be obtained. The size is more preferably from 3.0 μm or less.

The amount of Neuburg siliceous earth particles blended is preferably 5 parts by mass or more and 300 parts by mass or less based on 100 parts by mass of the carboxyl group-containing resin. When the amount is less than 5 parts by mass, the effect is not confirmed. On one hand, when the amount exceeds 300 parts by mass, there is a concern that dispersion is poor as a photocurable resin composition and the significant improvement of thixotropy and the like may be caused. The amount is more preferably from 20 parts by mass to 250 parts by mass.

Examples of the Neuburg siliceous earth particles include Sillitin V85, Sillitin V88, Sillitin N82, Sillitin N85, Sillitin N87, Sillitin Z86, Sillitin Z89, Sillicoloid P87, Sillitin N85 Puriss, Sillitin Z86 Puriss, Sillitin Z89 Puriss, Sillicoloid P87 Puriss, (all trade names; manufactured by Hoffmann-Mineral GmbH) and the like. These may be used either alone or in combination of two or more thereof.

The Neuburg siliceous earth particles are preferably surface-treated in order to obtain wettability sufficient for resins. Surface treatment (silane coupling treatment) may be performed by, for example, aminosilane, mercapto silane or vinyl silane, methacryl silane, epoxy silane, alkyl silane and the like.

Examples of the surface-treated Neuburg siliceous earth particles include Aktisil VM56, Aktisil MAM, Aktisil MAM-R, Aktisil EM, Aktisil AM, Aktisil MM, Aktisil PF777 (all trade names; manufactured by Hoffmann-Mineral GmbH) and the like. These may be used either alone or in combination of two or more thereof.

Further, the photocurable resin composition of the exemplary embodiment may use a silane coupling agent in order to improve the wettability of Neuburg siliceous earth particles and resins. The silane coupling agent is a compound consisting of an organic material (organic group) and silicon, and has two or more different reactive groups in a molecule. For this reason, the silane coupling agent acts as a mediation which links organic materials and inorganic materials which are very difficult to be typically connected with each other, and is used for strength improvement of a composite material, modification of a resin, surface modification and the like.

As described above, the silane coupling agent acts very effectively in that the Neuburg siliceous earth particles consist of silica and kaolinite. Accordingly, wettability sufficient for resins may be obtained by adding a silane coupling agent thereto.

In (surface)-untreated Neuburg siliceous earth particles, surface treatment is performed and wettability to a resin may be effectively improved by using a silane coupling agent. Even in the surface-treated Neuburg siliceous earth particles, the improvement of wettability may be further obtained. For example, as described above, when dispersion and sorting is performed using a disperser such as jet mill, bead mill and the like, the surface area is increased, and thus the surface treatment may be certainly performed by further adding a silane coupling agent.

The amount of the silane coupling agent blended is preferably 0.1 part by mass or more and 10 parts by mass or less based on 100 parts by mass of the carboxyl group-containing resin. When the amount is less than 0.1 part bymass, the effect is not confirmed. On one hand, when the amount exceeds 10 parts by mass, the photocurable resin composition is thickened or a production cost increases. The amount is more preferably 5 parts by mass or less, or 5 wt % or less based on the amount of the Neuburg siliceous earth particles used.

Examples of an organic group contained in the silane coupling agent include a vinyl group, an epoxy group, a styryl group, a methacryloxy group, an acryloxy group, an amino group, an ureido group, a chloropropyl group, a mercapto group, a polysulfide group, an isocyanate group and the like.

Examples of commercially available products of the silane coupling agent include KA-1003, KBM-1003, KBE-1003, KBM-303, KBM-403, KBE-402, KBE-403, KBM-1403, KBM-502, KBM-503, KBE-502, KBE-503, KBM-5103, KBM-602, KBM-603, KBE-603, KBM-903, KBE-903, KBE-9103, KBM-9103, KBM-573, KBM-575, KBM-6123, KBE-585, KBM-703, KBM-802, KBM-803, KBE-846, KBE-9007 (all trade name; manufactured by Shin-Etsu Silicon Corporation) and the like. These may be used either alone or in combination of two or more thereof.

As described above, wettability sufficient for resins may be obtained by surface treatment of the Neuburg siliceous earth particles or addition of the silane coupling agent, and thus the interface between resins and the Neuburg siliceous earth particles no longer exists and it is possible to improve all the characteristics such as improved insulation reliability, PCT resistance, physical properties of a cured article and the like.

Further, if necessary, in order to increase the physical strength of a coating film or a cured article, other fillers may be blended therewith. As the filler, known inorganic or organic fillers may be used. However, barium sulfate, spherical silica and talc are particularly preferred. In addition, in order to obtain the appearance of the white color or flame retardancy, titanium oxide or a metal oxide, a metal hydroxide such as aluminum hydroxide and the like may also be used as a filler.

Furthermore, in the photocurable resin composition of the exemplary embodiment, a thermosetting component may be added in order to impart heat resistance. As the thermosetting component, a known thermosetting resin, such as isocyanate, a block isocyanate compound, an amino resin, a polyfunctional epoxy compound, a polyfunctional oxetane compound, an episulfide resin, a melamine derivative, a benzoguanamine derivative, a maleimide compound, a benzo oxazine resin, a carbodiimide resin, a cyclocarbonate compound and the like, may be used.

Among them, isocyanate, a block isocyanate compound or an amino resin may be readily reacted with a hydroxyl group or a carboxyl group. By allowing the compounds to be reacted with each other, it is possible to obtain a cured article, which is incorporated into a strong 3-D network and to which flexibility is significantly imparted.

In particular, among the above-described thermosetting components, it is preferred that the thermosetting components preferably have two or more cyclic ether groups and/or cyclic thioether groups (hereinafter, briefly referred to as cyclic (thio)ether groups) in a molecule thereof. Many kinds of the thermosetting components having these cyclic (thio)ether groups are commercially available and may impart various properties according to structures thereof.

The thermosetting component having two or more cyclic (thio)ether groups in a molecule thereof is a compound having two or more of either one or two kinds of groups of 3-, 4- or 5-membered cyclic ether groups or cyclic thioether groups in the molecule thereof. Examples thereof include a compound having at least two epoxy groups in the molecule thereof, that is, a polyfunctional epoxy compound, a compound having at least two oxetanyl groups in the molecule thereof, that is, a polyfunctional oxetane compound, a compound having two or more thioether groups in the molecule thereof, that is, an episulfide resin and the like.

Examples of the polyfunctional epoxy compound include bisphenol A type epoxy resins, brominated epoxy resins, novolac type epoxy resins, bisphenol F type epoxy resins, hydrogenated bisphenol A type epoxy resins, glycidylamine type epoxy resins, hydantoin type epoxy resins, alicyclic epoxy resins, trihydroxyphenyl methane type epoxy resins, bixylenol type or biphenol type epoxy resins or mixtures thereof, bisphenol S type epoxy resins, bisphenol A novolac type epoxy resins, tetraphenylol ethane type epoxy resins, heterocyclic epoxy resins, diglycidyl phthalate resins, tetraglycidyl xylenoyl ethane resins, naphthalene group-containing epoxy resins, epoxy resins having a dicyclopentadiene skeleton, glycidylmethacrylate copolymer type epoxy resins, copolymeric epoxy resins of cyclohexylmaleimide and glycidyl methacrylate, epoxy-modified polybutadiene rubber derivatives, CTBN-modified epoxy resins and the like, but the polyfunctional epoxy compound is not limited thereto. These polyfunctional epoxy resins may be used either alone or in combination of two or more thereof.

Examples of the polyfunctional oxetane compounds include polyfunctional oxetanes such as bis[(3-methyl-3-oxetanylmethoxy)methyl]ether, bis[(3-ethyl-3-oxetanylmethoxy)methyl]ether, 1,4-bis[(3-methyl-3-oxetanylmethoxy)methyl]benzene, 1,4-bis[(3-ethyl-3-oxetanylmethoxy)methyl]benzene, (3-methyl-3-oxetanyl)methyl acrylate, (3-ethyl-3-oxetanyl)methyl acrylate, (3-methyl-3-oxetanyl)methyl methacrylate, (3-ethyl-3-oxetanyl)methyl methacrylate, oligomers or polymers thereof and the like, and etherified products of an oxetane alcohol with a resin having a hydroxyl group, such as a novolac resin, poly(p-hydroxy styrene), cardo type bisphenols, calixarenes, calixresorcinarenes, or silsesquioxane and the like. Besides, copolymers of an unsaturated monomer having an oxetane ring with an alkyl(meth)acrylate and the like may be included. These polyfunctional oxetane compounds may be used either alone or in combination of two or more thereof.

Examples of the episulfide resin include bisphenol A type episulfide resin and the like. Further, an episulfide resin with a sulfur atom substituted with an oxygen atom of an epoxy group of a novolac type epoxy resin obtained by using the same synthetic method and the like may also be used. These episulfide resins may be used either alone or in combination of two or more thereof.

The amount of a thermosetting component having two or more cyclic (thio)ether groups in the molecule thereof blended is preferably from 0.6 equivalent to 2.5 equivalents per one equivalent of the carboxyl group of the carboxyl group-containing resin. When the amount of the thermosetting component having two or more cyclic (thio)ether groups in the molecule thereof blended is less than 0.6, the carboxyl group remains in a solder resist film, and heat resistance, alkali resistance, electrical insulating properties and the like are deteriorated. On one hand, when the amount exceeds 2.5 equivalents, a cyclic (thio)ether group having a low molecular weight remains in a coating film, and thus the strength of the coating film and the like are reduced. The amount is more preferably from 0.8 equivalent to 2.0 equivalents.

In addition, as a thermosetting component which may be appropriately used, melamine derivatives, benzoguanamine derivatives and the like may be included. Examples thereof include a methylol melamine compound, a methylol benzoguanamine compound, a methylol glycol uryl compound, a methylol urea compound and the like. Furthermore, an alkoxymethylated melamine compound, an alkoxymethylated benzoguanamine compound, an alkoxymethylated glycol uryl compound, and an alkoxymethylated urea compound may be obtained by converting the methylol group of each methylol melamine compound, methylol benzoguanamine compound, methylol glycol uryl compound and methylol urea compound to an alkoxymethyl group. The kind of the alkoxymethyl group is not particularly limited, and examples thereof include a methoxymethyl group, an ethoxymethyl group, a propoxymethyl group, a butoxymethyl group and the like. A melamine derivative with a formalin concentration of 0.2% or less, which is mild to a human or an environment, is particularly preferred. These melamine derivatives and benzoguanamine derivatives may be used either alone or in combination of two or more thereof.

Further, examples of the isocyanate and block isocyanate compounds include a compound having two or more isocyanate group in one molecule thereof, that is, a polyisocyanate compound, or a compound having two or more blocked isocyanate groups in one molecule thereof, that is, a block isocyanate compound and the like. The curability of the photocurable resin composition of the composition and the toughness of the cured article obtained may be improved by using the compounds.

As the polyisocyanate compound, for example, an aromatic polyisocyanate, an aliphatic polyisocyanate or an alicyclic polyisocyanate may be used.

Specific examples of the aromatic polyisocyanate include 4,4′-diphenylmethanediisocyanate, 2,4-tolylenediisocyanate, 2,6-tolylenediisocyanate, naphthalene-1,5-diisocyanate, o-xylene diisocyanate, m-xylene diisocyanate and a 2,4-tolylene dimer.

Specific examples of the aliphatic polyisocyanate include tetramethylene diisocyanate, hexamethylenediisocyanate, methylene diisocyanate, trimethylhexamethylene diisocyanate, 4,4-methylene bis(cyclohexylisocyanate) and isophorone diisocyanate.

Specific examples of the alicyclic polyisocyanate include bicycloheptane triisocyanate. In addition, adducts, biurets and isocyanurates of the isocyanate compounds previously mentioned may be used.

The blocked isocyanate group included in a block isocyanate compound is a group which is protected by reaction of an isocyanate group with a blocking agent and is temporarily inactivated. When the blocked isocyanate group is heated to a predetermined temperature, the blocking agent is dissociated to produce an isocyanate group.

As the block isocyanate compound, an addition reaction product of an isocyanate compound with an isocyanate blocking agent is used. Examples of the isocyanate compound which may be reacted with a blocking agent include isocyanurate types, biuret types, adduct types and the like. As the isocyanate compound, for example, the above-described aromatic polyisocyanate, aliphatic polyisocyanate or alicyclic polyisocyanate may be used.

Examples of the isocyanate blocking agent include a phenol-based blocking agent such as phenol, cresol, xylenol, chlorophenol, ethylphenol and the like; a lactam-based blocking agent such as ε-caprolactam, δ-valerolactam, γ-butyrolactam, β-propiolactam and the like; an activated methylene-based blocking agent such as ethyl acetoacetate, acetyl acetone and the like; an alcohol-based blocking agent such as methanol, ethanol, propanol, butanol, amyl alcohol, ethylene glycol monomethyl ether, ethylene glycol monoethyl ether, ethylene glycol monobutyl ether, diethylene glycol monomethyl ether, propylene glycol monomethyl ether, benzyl ether, methyl glycolate, butyl glycolate, diacetone alcohol, methyl lactate, ethyl lactate and the like; an oxime-based blocking agent such as formaldehyde oxime, acetaldoxime, acetoxime, methyl ethyl ketoxime, diacetyl monooxime, cyclohexane oxime and the like; a mercaptan-based blocking agent such as butylmercaptan, hexylmercaptan, t-butylmercaptan, thiophenol, methylthiophenol, ethylthiophenol and the like; an acid amide-based blocking agent such as acetic acid amide, benzamide and the like; an imide-based blocking agent such as succinic acid imide and maleic acid imide; an amine-based blocking agent such as xylidine, aniline, butylamine, dibutylamine and the like; an imidazole-based blocking agent such as imidazole, 2-ethylimidazole and the like; and an imine-based blocking agent such as methyleneimine, propyleneimine and the like.

These polyisocyanate compounds and block isocyanate compounds may be used either alone or in combination of two or more thereof.

The amount of the polyisocyanate and block isocyanate compounds blended is preferably from 1 part by mass to 100 parts by mass based on 100 parts by mass of the carboxyl group-containing resin. When the blending amount is less than 1 part by mass, a sufficient toughness of a coating film may not be obtained. On one hand, when the amount exceeds 100 parts by mass, storage stability is reduced. The amount is more preferably from 2 parts by mass to 70 parts by mass.

In order to promote the curing reaction of a hydroxyl group or a carboxyl group with an isocyanate group, an urethanated catalyst may be added to the photocurable resin composition of the exemplary embodiment. As the urethanated catalyst, one or more urethanated catalysts selected from the group consisting of a tin-based catalyst, a metal chloride, a metal acetylacetonate salt, a metal sulfate, an amine compound or/and an amine salt are preferably used.

Examples of the tin-based catalyst include an organic tin compound such as stannous octoate, dibutyltin dilaurate and the like, an inorganic tin compound and the like.

The metal chloride is a chloride of a metal consisting of Cr, Mn, Co, Ni, Fe, Cu or Al, and examples thereof include cobaltic chloride, nickelous chloride, ferric chloride and the like.

The metal acetylacetonate salt is an acetylacetonate salt of a metal consisting of Cr, Mn, Co, Ni, Fe, Cu or Al, and examples thereof include cobalt acetylacetonate, nickel acetylacetonate, iron acetylacetonate and the like.

The metal sulfate is a sulfate of a metal consisting of Cr, Mn, Co, Ni, Fe, Cu or Al, and examples thereof include copper sulfate and the like.

Examples of the amine compound include known triethylenediamine, N,N,N′,N′-tetramethyl-1,6-hexanediamine, bis(2-dimethylaminoethyl)ether, N,N,N′,N″,N″-pentamethyl diethylenetriamine, N-methyl morpholine, N-ethyl morpholine, N,N-dimethylethanolamine, dimorpholinodiethylether, N-methylimidazole, dimethylaminopyridine, triazine, N′-(2-hydroxyethyl)-N,N,N′-trimethyl-bis(2-aminoethyl)ether, N,N-dimethylhexanolamine, N,N-dimethylaminoethoxyethanol, N,N,N′-trimethyl-N′-(2-hydroxyethyl)ethylenediamine, N-(2-hydroxyethyl)-N,N′,N″,N″-tetramethyldiethylenetriamine, N-(2-hydroxypropyl)-N,N′,N″, N″-tetramethyldiethylenetriamine, N,N,N′-trimethyl-N′-(2-hydroxyethyl)propanediamine, N-methyl-N′-(2-hydroxyethyl)piperazine, bis(N,N-dimethylaminopropyl)amine, bis(N,N-dimethylaminopropyl)isopropanolamine, 2-amino quinuclidine, 3-amino quinuclidine, 4-amino quinuclidine, 2-quinuclidiol, 3-quinuclidinol, 4-quinuclidinol, 1-(2′-hydroxypropyl)imidazole, 1-(2′-hydroxypropyl)-2-methylimidazole, 1-(2′-hydroxyethyl)imidazole, 1-(2′-hydroxyethyl)-2-methylimidazole, 1-(2′-hydroxypropyl)-2-methylimidazole, 1-(3′-aminopropyl)imidazole, 1-(3′-aminopropyl)-2-methylimidazole, 1-(3′-hydroxypropyl)imidazole, 1-(3′-hydroxypropyl)-2-methylimidazole, N,N-dimethylaminopropyl-N′-(2-hydroxyethyl)amine, N,N-dimethylaminopropyl-N′,N′-bis(2-hydroxyethyl)amine, N,N-dimethylaminopropyl-N′,N′-bis(2-hydroxypropyl)amine, N,N-dimethylaminoethyl-N′,N′-bis(2-hydroxyethyl)amine, N,N-dimethylaminoethyl-N′,N′-bis(2-hydroxypropyl)amine, melamine or/and benzoguanamine and the like.

Examples of the amine salt include an organic acid salt-based amine salt of DBU (1,8-diazabicyclo[5,4,0]undecen-7) and the like.

The amount of the urethanated catalyst blended which is used at common quantitative ratio is sufficient, and for example, preferably from 0.1 part by mass to 20 parts by mass and more preferably from 0.5 part by mass to 10.0 parts by mass based on 100 parts bymass of the carboxyl group-containing resin.

When a thermosetting component having two or more cyclic (thio)ether groups is used among the above-described molecules, it is preferred that a thermosetting catalyst is contained. Examples of the thermosetting catalyst include imidazole derivatives such as imidazole, 2-methylimidazole, 2-ethylimidazole, 2-ethyl-4-methylimidazole, 2-phenylimidazole, 4-phenylimidazole, 1-cyanoethyl-2-phenylimidazole, 1-(2-cyanoethyl)-2-ethyl-4-methylimidazole and the like; amine compounds such as dicyandiamide, benzyldimethylamine, 4-(dimethylamino)-N,N-dimethylbenzylamine, 4-methoxy-N,N-dimethylbenzylamine, 4-methyl-N,N-dimethylbenzylamine and the like, hydrazine compounds such as adipic dihydrazide, sebacic dihydrazide and the like; and phosphorus compounds such as triphenylphosphine and the like, block isocyanate compounds of dimethyl amine, bicyclic amidine compounds, salts thereof and the like.

In particular, the catalyst is not limited thereto, may be a thermosetting catalyst of an epoxy resin or an oxetane compound or a catalyst that promotes the reaction of a carboxyl group with an epoxy group and/or an oxetanyl group, and may be used either alone or in combination of two or more thereof. In addition, guanamine, acetoguanamine, benzoguanamine, melamine, and S-triazine derivatives such as 2,4-diamino-6-methacryloyloxyethyl-S-triazine, 2-vinyl-2,4-diamino-S-triazine, 2-vinyl-4,6-diamino-S-triazine isocyanuric acid adduct, and 2,4-diamino-6-methacryloyloxyethyl-S-triazine isocyanuric acid adduct and the like may be used. Furthermore, it is preferred that compounds which also function as an agent for imparting adhesion are used in combination with a thermocuring catalyst.

The amount of the thermocuring catalysts blended which is used at common quantitative ratio is sufficient, and is preferably from 0.1 part by mass to 20 parts by mass and more preferably 0.5 part by mass to 15.0 parts by mass based on 100 parts by mass of, for example, the carboxyl group-containing resin) or the thermosetting component having two or more cyclic (thio)ether groups in a molecule thereof.

Further, the photocurable resin composition of the exemplary embodiment may blend a coloring agent therein. As the coloring agent, a known coloring agent of red, blue, green, yellow and the like may be used and any of pigments, dyes and coloring materials may be appropriate. However, it is preferred that the halogen is not contained from the viewpoint of reducing environmental load and influence on a human body.

Examples of the red coloring agent include monoazo-based, disazo-based, azo rake-based, benzimidazolone-based, perylene-based, diketo pyrrolo pyrrole-based, condensation azo-based, anthraquinone-based, quinacridone-based coloring agents and the like.

Examples of the blue coloring agent include phthalocyanine-based and anthraquinone-based coloring agents. Besides, a phthalocyanine compound which is substituted or not substituted with metal may also be used.

As the green coloring agent, similarly there are phthalocyanine-based, anthraquinone-based, and perylene-based coloring agents. Besides, a phthalocyanine compound which is substituted or not substituted with metal may also be used.

Examples of the yellow coloring agent include monoazo-based, disazo-based, condensation azo-based, benzimidazolone-based, isoindolinone-based, and anthraquinone-based coloring agents.

Besides, coloring agents of violet, orange, brown, black and the like may be added to the composition for the purpose of adjusting a color tone.

The amount of the coloring agents blended is not particularly limited, but is sufficient to be from 0 part by mass to 10 parts by mass based on 100 parts by mass of the carboxyl group-containing resin. The amount is more preferably from 0.1 part by mass to 5 parts by mass.

In addition, the photocurable resin composition of the exemplary embodiment may contain a compound which has two or more ethylenically unsaturated groups in the molecule thereof in order to help the carboxyl group-containing resin to be insolubilized in an alkaline aqueous solution or the insolubilization of the carboxyl group-containing resin by being subjected to photocuring by irradiation with an active energy ray. As the compound, known polyester(meth)acrylates, polyether(meth)acrylates, urethane(meth)acrylates, carbonate(meth)acrylates, epoxy(meth)acrylates and the like may be used. Specific examples thereof include hydroxyalkyl acrylates such as 2-hydroxyethyl acrylate, 2-hydroxypropyl acrylate and the like; diacrylates of glycols such as ethylene glycol, methoxytetraethylene glycol, polyethylene glycol, propylene glycol and the like; acrylamides such as N,N-dimethyl acrylamide, N-methylol acrylamide, N,N-dimethylaminopropyl acrylamide and the like; aminoalkyl acrylates such as N,N-dimethylaminoethyl acrylate, N,N-dimethylaminopropyl acrylate and the like; multivalent acrylates of polyhydric alcohols, such as hexane diol, trimethylol propane, pentaerythritol, dipentaerythritol, tris-hydroxyethyl isocyanurate and the like or ethylene oxide adducts thereof, propylene oxide adducts, or ε-caprolactone adducts thereof and the like; multivalent acrylates such as phenoxy acrylate, bisphenol A diacrylate and ethylene oxide adducts or propylene oxide adducts of phenols thereof and the like; multivalent acrylates of glycidyl ethers such as glycerin diglycidyl ether, glycerin triglycidyl ether, trimethylol propane triglycidyl ether, triglycidyl isocyanurate and the like; not limiting thereto, acrylates obtained by directly acrylating or urethane-acrylating via a diisocyanate a polyol such as polyether polyol, polycarbonate diol, hydroxyl group-terminated polybutadiene, polyester polyol and the like; and melamine acrylate and/or each of methacrylates corresponding to the acrylates enumerated above.

In addition, an epoxy acrylate resin obtained by the reaction of a polyfunctional epoxy resin such as a cresol novolac type epoxy resin and the like with acrylic acid, an epoxy urethane acrylate compound obtained by causing a half urethane compound of a hydroxyl acrylate such as pentaerythritol triacrylate and the like and a diisocyanate such as isophorone diisocyanate and the like to react with the hydroxyl group of the epoxy acrylate resin, and the like may be included. Such an epoxy acrylate-based resin may improve the photocuring properties, without deteriorating the finger-touch dryness.

The amount of a compound having two or more ethylenically unsaturated groups in the molecule thereof blended is preferably from 5 parts by mass to 100 parts by mass, based on 100 parts by mass of the carboxyl group-containing resin. When the amount of the compound blended is less than 5 parts by mass, the photocuring properties thereof are deteriorated, and after irradiation with an active energy ray, it is difficult to form a pattern with an alkali development. On one hand, when the amount exceeds 100 parts by mass, the solubility of the composition in an alkaline aqueous solution is deteriorated and a coating film becomes brittle. The amount is more preferably from 1 part by mass to 70 parts by mass.

Further, the photocurable resin composition of the exemplary embodiment may contain a binder polymer for the purpose of improving the finger-touch dryness or improving the handling characteristics thereof. For example, a polyester-based polymer, a polyurethane-based polymer, a polyester urethane-based polymer, a polyamide-based polymer, a polyester amide-based polymer, an acrylic polymer, a cellulose-based polymer, a polylactic acid-based polymer, a phenoxy-based polymer and the like may be used. These binder polymers may be used either alone or in the form of a mixture of two or more thereof.

In addition, elastomers may be used for the photocurable resin composition of the exemplary embodiment for the purpose of imparting flexibility to, improving brittleness of a cured article and the like.

In particular, the hydroxyl group-containing elastomer may be incorporated into a strong 3-D network by reacting the hydroxyl group thereof with a hydroxyl group produced by reaction of a carboxyl group with a cyclic (thio)ether group (for example, an expoxy group), or furthermore reacting the hydroxyl groups with each other. Accordingly, a cured article to which flexibility is significantly imparted may be obtained by using an amino resin capable of readily being reacted with a hydroxyl group or a carboxyl group, isocyanate or block isocyanates.

Besides, for example, a polyester-based elastomer, a polyurethane-based elastomer, a polyester urethane-based elastomer, a polyamide-based elastomer, a polyester amide-based elastomer, an acrylic elastomer and an olefin-based elastomer may be used. Further, any resins obtained by modifying a part or the whole of the epoxy groups of the epoxy resins having various skeletons with a butadiene-acrylonitrile rubber of which both ends are modified to carboxyl groups and the like may also be used. In addition, an epoxy-containing polybutadiene-based elastomer, an acryl-containing polybutadiene-based elastomer and the like may be used. These elastomers may be used either alone or in the form of a mixture of two or more thereof.

The photocurable resin composition of the exemplary embodiment may contain an organic solvent for the synthesis of the carboxyl group-containing resin or adjustment of the composition or for adjusting the viscosity of the composition for application to a substrate or a carrier film.

Examples of the organic solvent include ketones, aromatic hydrocarbons, glycol ethers, glycol ether acetates, esters, alcohols, aliphatic hydrocarbons, petroleum-based solvents and the like. More specific examples thereof include ketones such as methylethyl ketone, cyclohexanone and the like; aromatic hydrocarbons such as toluene, xylene, tetramethyl benzene and the like; glycol ethers such as cellosolve, methyl cellosolve, butyl cellosolve, carbitol, methyl carbitol, butyl carbitol, propylene glycol monomethyl ether, dipropylene glycol monomethyl ether, dipropylene glycol diethyl ether, triethylene glycol monoethyl ether and the like; esters such as ethyl acetate, butyl acetate, dipropylene glycol methyl ether acetate, propylene glycol methyl ether acetate, propylene glycol ethyl ether acetate, propylene glycol butyl ether acetate and the like; alcohols such as ethanol, propanol, ethylene glycol, propylene glycol and the like; aliphatic hydrocarbons such as octane, decane and the like; and petroleum-based solvents such as petroleum ether, petroleum naphtha, hydrogenated petroleum naphtha, solvent naphtha and the like; and the like. These organic solvents may be used either alone or in the form of a mixture of two or more thereof.

Further, in order to prevent the oxidation, an antioxidant may be added to the photocurable resin composition of the exemplary embodiment. In general, once the oxidation begins, most of the polymer materials undergo subsequent oxidative degradation, thereby causing the deterioration in functions of polymer materials. The deterioration in functions thereof may be suppressed by adding an antioxidant thereto.

The antioxidants may include radical scavengers which nullify radicals generated or antioxidants functioning as a peroxide dissociating agent which dissociates peroxides generated into harmless materials and prevents further generation of radicals.

Specific examples of the antioxidant that functions as a radical scavenger include phenol-based such as hydroquinone, 4-t-butyl catechol, 2-t-butyl hydroquinone, hydroquinone monomethyl ether, 2,6-di-t-butyl-p-cresol, 2,2-methylene-bis(4-methyl-6-t-butyl phenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, 1,3,5-tris(3′,5′-di-t-butyl-4-hydroxybenzyl)-S-triazine-2,4,6-(1H,3H,5H)trione, and the like, quinine-based compounds such as metaquinone, benzoquinone and the like, amine-based compounds such as bis(2,2,6,6-tetramethyl-4-piperidyl)-sebacate, phenothiazine and the like, and the like.

Specific examples of the antioxidant functioning as a peroxide dissociating agent include phosphorus-based compounds such as triphenyl phosphate and the like, sulfur-based compounds such as pentaerythritol tetralauryl thiopropionate, dilauryl thiodipropionate, distearyl 3,3′-thiodipropionate and the like, and the like.

These antioxidants may be used either alone or in combination of two or more thereof.

The photocurable resin composition of the exemplary embodiment may contain an ultraviolet light (UV) absorbent. In general, polymer materials absorb light and cause decomposition and deterioration, but it is possible to obtain stabilization to ultraviolet light by adding an UV absorbent.

Examples of the ultraviolet absorbent include benzophenone derivatives, benzoate derivatives, benzotriazole derivatives, triazine derivatives, benzothiazole derivatives, cinnamate derivatives, anthranylate derivatives, dibenzoylmethane derivatives and the like.

Specific examples of the benzophenone derivatives include 2-hydroxy-4-methoxy-benzophenone, 2-hydroxy-4-n-octoxybenzophenone, 2,2′-dihydroxy-4-methoxybenzophenone, 2,4-dihydroxybenzophenone and the like.

Specific examples of the benzoate derivatives include 2-ethylhexylsalicylate, phenylsalicylate, p-t-butylphenylsalicylate, 2,4-di-t-butylphenyl-3,5-di-t-butyl-4-hydroxybenzoate, hexadecyl-3,5-di-t-butyl-4-hydroxybenzoate and the like.

Specific examples of the benzotriazole derivatives include 2-(2′-hydroxy-5′-t-butylphenyl)benzotriazole, 2-(2′-hydroxy-5′-methylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-5′-methylphenyl)benzotriazole, 2-(2′-hydroxy-3′,5′-di-t-amylphenyl)benzotriazole and the like.

Specific examples of the triazine derivatives include hydroxyphenyltriazine, bisethylhexyloxyphenol methoxyphenyltriazine and the like.

These UV absorbents may be used either alone or in combination of two or more thereof. Further, when used in combination of an antioxidant, a cured article obtained from the photocurable resin composition of the exemplary embodiment may be stabilized.

For the photocurable resin composition of the exemplary embodiment, N phenyl glycines, phenoxyacetic acids, thiophenoxy acetic acids, mercaptothiazole and the like that are well known in the art may be used as a chain transfer agent in order to enhance the sensitivity.

Specific examples thereof include a chain transfer agent having a carboxyl group such as mercaptosuccinic acid, mercaptoacetic acid, mercaptopropionic acid, methionine, cysteine, thiosalicylic acid, derivatives thereof and the like; a chain transfer agent having a hydroxyl group such as mercaptoethanol, mercaptopropanol, mercaptobutanol, mercaptopropane diol, mercaptobutane diol, hydroxybenzene thiol, derivatives thereof and the like; and 1-butanethiol, butyl-3-mercaptopropionate, methyl-3-mercaptopropionate, 2,2-(ethylenedioxy)diethanethiol, ethanethiol, 4-methylbenzene thiol, dodecylmercaptan, propane thiol, butane thiol, pentane thiol, 1-octane thiol, cyclopentane thiol, cyclohexane thiol, thioglycerol, 4,4-thiobisbenzene thiol and the like.

Further, a polyfunctional mercaptan-based compound may be used. The polyfunctional mercaptan-based compound is not particularly limited, but specific examples thereof include aliphatic thiols such as hexane-1,6-dithiol, decane-1,10-dithiol, dimercapto diethyl ether, dimercapto diethyl sulfide and the like; aromatic thiols such as xylylene dimercaptan, 4,4′-dimercaptodiphenyl sulfide, 1,4-benzenedithiol and the like; poly(mercaptoacetates) of polyhydric alcohol such as ethylene glycol bis(mercaptoacetate), polyethylene glycol bis(mercaptoacetate), propylene glycol bis(mercaptoacetate), glycerin tris(mercaptoacetate), trimethylolethane tris(mercaptoacetate), trimethylol propanetris(mercaptoacetate), pentaerythritoltetrakis(mercaptoacetate), dipentaerythritolhexakis(mercaptoacetate) and the like; poly(3-mercaptopropionates) of polyhydric alcohol such as ethylene glycol bis(3-mercaptopropionate), polyethylene glycol bis(3-mercaptopropionate), propylene glycol bis(3-mercaptopropionate), glycerin tris(3-mercaptopropionate), trimethylolethane tris(mercaptopropionate), trimethylol propanetris(3-mercaptopropionate), pentaerythritoltetrakis(3-mercaptopropionate), dipentaerythritolhexakis(3-mercaptopropionate) and the like; and poly(mercaptobutyrates) such as 1,4-bis(3-mercaptobutyryloxy)butane, 1,3,5-tris(3-mercaptobutyloxyethyl)-1,3,5-triazine-2,4,6(1H,3H,5H)-trione, pentaerythritoltetrakis(3-mercaptobutyrate) and the like.

Further, a heterocyclic compound having a mercapto group may be used as a chain transfer agent. Specific examples thereof include mercapto-4-butyrolactone (another name:
2-mercapto-4-butanolide),
2-mercapto-4-methyl-4-butyrolactone,
2-mercapto-4-ethyl-4-butyrolactone,
2-mercapto-4-butyrothiolactone,
2-mercapto-4-butyrolactam,
N-methoxy-2-mercapto-4-butyrolactam,
N-ethoxy-2-mercapto-4-butyrolactam,
N-methyl-2-mercapto-4-butyrolactam,
N-ethyl-2-mercapto-4-butyrolactam,
N-(2-methoxy)ethyl-2-mercapto-4-butyrolactam,
N-(2-ethoxy)ethyl-2-mercapto-4-butyrolactam,
2-mercapto-5-valerolactone,
2-mercapto-5-valerolactam,
N-methyl-2-mercapto-5-valerolactam,
N-ethyl-2-mercapto-5-valerolactam,
N-(2-methoxy)ethyl-2-mercapto-5-valerolactam,
N-(2-ethoxy)ethyl-2-mercapto-5-valerolactam,
2-mercaptobenzothiazole,
2-mercapto-5-methylthio-thiadiazole,
2-mercapto-6-hexanolactam,
2,4,6-trimercapto-s-triazine,
2-dibutylamino-4,6-dimercapto-s-triazine,
2-anilino-4,6-dimercapto-s-triazine and the like.

In particular, mercaptobenzothiazole, 3-mercapto-4-methyl-4H-1,2,4-triazole, 5-methyl-1,3,4-thiadiazole-2-thiol and 1-phenyl-5-mercapto-1H-tetrazole, which do not impair the developability of the photocurable resin composition, are preferred.

These chain transfer agents may be used either alone or in combination of two or more thereof.

The photocurable resin composition of the exemplary embodiment may contain an adhesion promoter in order to improve adhesion between layers or adhesion between a resin layer and a substrate. Specific examples thereof include benzoimidazole, benzoxazole, benzothiazole, 2-mercapto benzoimidazole, 2-mercapto benzoxazole, 2-mercapto benzothiazole, 3-morpholino methyl-1-phenyltriazol-2-thione, 5-amino-3-morpholinomethyl-thiazole-2-thione, 2-mercapto-5-methyl thio-thiadiazole, triazole, tetrazole, benzotriazole, carboxybenzotriazole, an amino group-containing benzotriazole, a silane coupling agent and the like.

The photocurable resin composition of the exemplary embodiment may also contain a thixo agent such as fine silica powder, organic bentonite, montmorillonite, HYDROTALCITE and the like, if necessary. Organic bentonite and HYDROTALCITE have high stability over time as a thixo agent, and in particular, the HYDROTALCITE has excellent electric properties.

Further, additives that are well known in the art, such as a thermal polymerization inhibitor, a defoaming agent and/or a leveling agent such as silicone-based, fluorine-based, or polymer-based agents and the like, a silane coupling agent such as imidazole-based, triazole-based, or triazole-based coupling agent and the like, an anti-rust agent and a copper inhibitor such as bisphenol-based, or triazinethiol-based inhibitor and the like may be blended.

The thermal polymerization inhibitor is used in order to prevent thermal polymerization or polymerization overtime of a polymerizable compound. Specific examples of the thermal polymerization inhibitor include 4-methoxy phenol, hydroquinone, alkyl or aryl-substituted hydroquinone, t-butyl catechol, pyrogallol, 2-hydroxybenzophenone, 4-methoxy-2-hydroxybenzophenone, copper (I) chloride, phenothiazine, chloranyl, naphthylamine, β-naphthol, 2,6-di-t-butyl-4-cresol, 2,2′-methylene bis(4-methyl-6-t-butyl phenol), pyridine, nitrobenzene, dinitrobenzene, picric acid, 4-toluidine, methylene blue, a reaction product between copper and an organic chelating agent, methyl salicylate, phenothiazine, a nitroso compound, a chelate between a nitroso compound and Al and the like.

The photocurable resin composition of the exemplary embodiment as configured above is, for example, used as follows.

First, after being adjusted with an organic solvent to have viscosity suitable for coating method, the composition is applied on a substrate according to a method including a dip coating method, a flow coating method, a roll coating method, a bar coater method, a screen printing method, a curtain coating method and the like. Moreover, a tack-free coating film is formed by volatilization drying (pseudo-drying) an organic solvent included in the composition at a temperature of from about 60° C. to about 100° C.

Subsequently, a pattern is selectively exposed by irradiation with active energy ray to perform photocuring of the exposed part. And then, unexposed parts are developed with an alkaline aqueous solution (for example 0.3% to 3% of aqueous solution of sodium carbonate) to form a pattern.

On the pattern formed, heat treatment (thermal curing) may be performed, if necessary. When a thermosetting component is contained, a thermosetting component having two or more cyclic ether groups and/or cyclic thioether groups in a molecule thereof is reacted with a carboxyl group of a carboxyl group-containing resin and a cured article having excellent characteristics such as heat resistance, chemical resistance, moisture resistance, adhesion, electrical characteristics and the like may be formed by performing thermal curing by heating to, for example, from about 140° C. to about 180° C. Further, even when the thermosetting component is not contained, the ethylenically unsaturated bonds of photocurable components remaining in an unreacted state during exposure may be subjected to thermal radical polymerization to improve characteristics of the coating film by performing heat treatment.

Herein, as a substrate on which a coating film is formed, in addition to a printed wiring board in which circuits are already formed or a flexible printed wiring board, a copper clad laminate plate of all grades (FR-4) using a composite such as a paper-phenol resin, a paper-epoxy resin, a glass fabric-epoxy resin, a glass-polyimide, a glass fabric/non-woven fabric-epoxy resin, a glass fabric/paper-epoxy resin, a synthetic fiber-epoxy resin, fluoro resin.polyethylene.PPO.cyanate ester and the like, a polyimide film, a PET film, a glass substrate, a ceramic substrate, a wafer plate and the like may be used.

Further, the volatilization drying may be performed by a method for countercurrent contact with hot air in a dryer or by a method of spraying hot air from a nozzle to a support using an apparatus equipped with a heat source for steam-based air heating system such as a hot air circulation drying furnace, an IR furnace, a hot plate, a convection oven and the like.

In addition, in irradiation with active energy ray, an exposure machine for performing pattern exposure on a coating film by using a photomask (contact, non-contact), or a direct patterning device for directly drawing an image on a coating film by CAD data from a computer may be used.

As a light source of the exposure machine, for example, a metal halide lamp, a (ultra) high pressure mercury lamp, a mercury short arc lamp or the like may be used. Further, as a light source of the direct patterning device, a laser such as a gas laser, a solid laser and the like, or an ultraviolet ray lamp such as an (ultra) high pressure mercury lamp and the like may be used. As the direct patterning device, a product manufactured by Nippon Orbotech Co., Ltd., PENTAX Corporation or the like may be used.

As the active energy ray, the maximum wavelength may be in a range of from 350 nm to 410 nm. The exposure amount thereof varies depending on the film thickness thereof, and is typically from 5 mJ/cm² to 500 mJ/cm² and preferably from 5 mJ/cm² to 200 mJ/cm².

As the development method, a dipping method, a shower method, a spray method, a brush method and the like may be used. In addition, as the developer, an alkaline aqueous solution such as potassium hydroxide, sodium hydroxide, sodium carbonate, potassium carbonate, sodium phosphate, sodium silicate, ammonia, amines and the like may be used.

The photocurable resin composition of the exemplary embodiment may be used in the form of a dry film in addition to the form of directly applying the liquid composition on a substrate.

The dry film has a structure in which a carrier film, a dry coating film obtained by applying and drying the photocurable resin composition and a peelable cover film used if necessary are sequentially laminated.

The dry film is obtained by forming a dry coating film on a carrier film, then laminating a cover film thereon or forming a dry coating film on a cover film, and laminating the stacked body on the carrier film. In this case, the dry coating film is formed, for example, by evenly coating the liquid photocurable resin composition to a thickness of from 10 μm to 150 μm using a blade coater, a lip coater, a comma coater, a film coater or the like followed by drying.

As the carrier film, a polyester film having a thickness of from 2 μm to 150 μm and a thermoplastic film such as polyethylene terephthalate and the like may be used. Further, as the cover film, a polyethylene film, a polypropylene film and the like may be used, but a film having smaller adhesiveness to a solder resist layer than a carrier film is appropriate.

In order to manufacture a protective film (a permanent protective film), for example, on a printed wiring board by using the dry film, a cover film is peeled off, if necessary, a dry coating film of the photocurable resin composition and a substrate in which circuits are formed are overlapped with and attached to each other by using a laminator and the like, and then a photocurable resin composition layer is formed on the substrate in which circuits are formed. Moreover, a cured article (a cured coating film) may be formed by similarly performing exposure, development and heat treatment (thermal curing) if necessary. In this case, the carrier film may be peeled off at either one time point of before or after exposure.

### EXAMPLES

Hereinafter, the exemplary embodiment will be described in detail with reference to Examples and comparative examples, but the present invention is not limited to the following Examples. Further, in the following description, the terms “part” and “%” are all on a mass basis unless otherwise specified.

### Synthesis of Carboxyl Group-Containing Resin

### Synthetic Example 1

Into an autoclave equipped with a thermometer, an apparatus for introducing nitrogen gas and alkylene oxide and a stirrer, 119.4 g of a novolac type cresol resin (manufactured by Showa Highpolymer Co., Ltd., trade name; Shonol (registered trademark) CRG951, and OH equivalent: 119.4), 1.19 g of potassium hydroxide and 119.4 g of toluene were injected and the temperature was increased by heating under stirring while purging the system with nitrogen.

Subsequently, 63.8 g of propylene oxide was slowly added dropwise thereto and reacted at from 125° C. to 132° C. and from 0 kg/cm² to 4.8 kg/cm² for 16 hours. Next, the system was cooled to room temperature, 1.56 g of 89% phosphoric acid was added to the reaction solution and the resulting solution was mixed to neutralize potassium hydroxide, and a propylene oxide reaction solution of a novolac type cresol resin having anon-volatile component content of 62.1% and a hydroxyl group value of 182.2 g/eq. was obtained. This means that average 1.08 mol of alkylene oxide was added per 1 eq. of a phenolic hydroxyl group.

And then, 293.0 g of an alkylene oxide reaction solution of the novolac type cresol resin obtained, 43.2 g of acrylic acid, 11.53 g of methanesulfonic acid, 0.18 g of methyl hydroquinone and 252.9 g of toluene were injected into a reactor equipped with a stirrer, a thermometer and an air blowing tube, and the reaction was performed at 110° C. for 12 hours under stirring while blowing air at the rate of 10 ml/min. The water produced by the reaction is an azeotropic mixture with toluene, and 12.6 g of water was distilled.

Next, the system was cooled to room temperature, and the reaction solution obtained was neutralized with 35.35 g of a 15% aqueous solution of sodium hydroxide followed by washing with water. And then, toluene was distilled off while being replaced with 118.1 g of diethylene glycol monoethyl ether acetate by an evaporator, and a solution of novolac type acrylate resin was obtained. Further, 332.5 g of the solution of the novolac type acrylate resin obtained and 1.22 g of triphenylphosphine were injected into a reactor equipped with a stirrer, a thermometer and an air blowing tube, 60.8 g of tetrahydrophthalic anhydride was slowly added thereto while blowing air at the rate of 10 ml/min and stirring the solution, and the reaction was performed at from 95° C. to 101° C. for 6 hours.

In this manner, a resin solution of a carboxyl group-containing photosensitive resin having a solid matter acid value of 88 mgKOH/g and a non-volatile component content of 71% was obtained. Hereinafter, this will be referred to as Varnish A-1.

### Synthetic Example 2

Into a 5-liter separable flask equipped with a thermometer, a stirrer and a reflux condenser, 1.245 g of polycaprolactone diol (manufactured by DAICEL CHEMICAL INDUSTRIES, LTD., and trade name: PLACCEL (registered trademark) 208, and molecular weight 830) as a polymer polyol, 201 g of dimethylol propionic acid as a dihydroxyl compound having a carboxyl group, 777 g of isophorone diisocyanate as polyisocyanate, 119 g of 2-hydroxyethylacrylate as (meth)acrylate having a hydroxyl group, and p-methoxyphenol and di-t-butyl-hydroxytoluene, each in 0.5 g, were introduced.

The mixture was heated to 60° C. under stirring, and after terminating the heating, 0.8 g of dibutyl tin dilaurate was added thereto. Once the temperature inside the reaction container starts to decrease, the mixture was heated again and stirred continuously at 80° C. After confirming the disappearance of absorption spectrum (2280 cm⁻¹) of the isocyanate group in IR absorption spectrum, the reaction was completed to obtain an urethane acrylate compound as a viscous liquid. By using carbitol acetate in the urethane acrylate compound obtained, the non-volatile component was adjusted to 50 mass %.

In this manner, a resin solution of an urethane(meth)acrylate compound having a carboxyl group with a solid matter acid value of 47 mgKOH/g and a non-volatile component content of 50% was obtained. Hereinafter, this will be referred to as Varnish A-2.

### Synthetic Example 3

To a 2-liter separable flask equipped with a stirrer, a thermometer, a reflux condenser, a dropping funnel and a nitrogen introducing tube, 900 g of diethylene glycol dimethyl ether as a solvent and 21.4 g of t-butyl peroxy 2-ethylhexanoate (manufactured by NOF CORPORATION, and trade name; PERBUTYL (registered trademark) O) as a polymerization initiator were added, and the mixture was heated to 90° C.

After heating, 309.9 g of methacrylic acid, 116.4 g of methyl methacrylate, 109.8 g of lactone-modified 2-hydroxyethyl methacrylate (manufactured by DAICEL CHEMICAL INDUSTRIES, LTD., and trade name: PLACCEL (registered trademark) FM1) and 21.4 g of bis(4-t-butyl cyclohexyl)peroxydicarbonate (manufactured by NOF CORPORATION, and trade name; PEROYL (registered trademark) TCP) which was a polymerization initiator were added dropwise thereto over 3 hours, and the mixture was further aged for 6 hours to obtain a carboxyl group-containing copolymer resin. In addition, the reaction was performed under nitrogen atmosphere.

Subsequently, to the carboxyl group-containing copolymer resin obtained, 363.9 g of 3,4-epoxycyclohexylmethyl acrylate (manufactured by DAICEL CHEMICAL INDUSTRIES, LTD., trade name: CYCLOMER A200), 3.6 g of dimethyl benzyl amine as a ring-opening catalyst and 1.80 g of hydroquinone monomethyl ether as a polymerization inhibitor were added, and the mixture was heated to 100° C. and stirred to perform a ring-opening addition reaction of epoxy for 16 hours.

In this manner, a resin solution having a solid matter acid value of 108.9 mgKOH/g, a weight average molecular weight of 25,000 and a solid content of 54% was obtained. Hereinafter, this will be referred to as Varnish A-3.

### Synthetic Example 4

Into 600 g of diethylene glycol monoethyl ether acetate, 1,070 g of an ortho-cresol novolac type epoxy resin (manufactured by DIC Corporation, trade name: EPICLON (registered trademark) N-695, softening point of 95° C., epoxy equivalent of 214, and average number of functional groups of 7.6) (number of glycidyl groups (total number of aromatic rings): 5.0 mol), 360 g (5.0 mol) of acrylic acid and 1.5 g of hydroquinone were injected, and the mixture was heated at 100° C. and stirred to dissolve the components homogeneously.

Subsequently, 4.3 g of triphenylphosphine was injected thereto and the mixture was reacted for 2 hours by heating to 110° C., and after increasing the temperature to 120° C., the reaction was further performed for 12 hours. Into the reaction solution obtained, 415 g of an aromatic-based hydrocarbon (SOLVESSO 150) and 456.0 g (3.0 mol) of tetrahydro anhydrous phthalic acid were injected, the reaction was performed at 110° C. for 4 hours, and the mixture was cooled.

In this manner, a resin solution having a solid matter acid value of 89 mgKOH/g and a solid content of 65% was obtained. Hereinafter, this will be referred to as Varnish R-1.

### Synthetic Example 5

2,200 parts of a cresol novolac type epoxy resin (manufactured by Nippon Kayaku Co., Ltd., trade name EOCN (registered trademark)-104S, softening point of 92° C., and epoxy equivalent of 220), 134 parts of dimethylol propionic acid, 648.5 parts of acrylic acid, 4.6 parts of methyl hydroquinone, 1,131 parts of carbitol acetate and 484.9 parts of solvent naphtha were injected, and the mixture heated to 90° C. and stirred to dissolve the reaction mixture.

Subsequently, the reaction solution was cooled to 60° C., 13.8 parts of triphenylphosphine was injected thereto, and the mixture was heated to 100° C. and reacted for about 32 hours to obtain a reactant having an acid value of 0.5 mgKOH/g. Next, 364.7 parts of tetrahydro anhydrous phthalic acid, 137.5 parts of carbitol acetate and 58.8 parts of solvent naphtha were injected thereto, and the mixture was heated to 95° C., reacted for about 6 hours and cooled.

In this manner, a resin solution of a carboxyl group-containing photosensitive resin having a solid matter acid value of 40 mgKOH/g and a non-volatile component content of 65% was obtained. Hereinafter, this will be referred to as Varnish R-2.

### Synthetic Example 6

400 parts of a bisphenol F type solid epoxy resin having an epoxy equivalent of 800 and a softening point of 79° C. was dissolved in 925 parts of epichlorohydrin and 462.5 parts of dimethyl sulfoxide, and then, 81.2 parts of 98.5% NaOH was added thereto over 100 minutes at 70° C. under stirring. After the completion of the addition, the reaction was further performed at 70° C. for 3 hours.

Subsequently, an excess of unreacted epichlorohydrin and most of the dimethyl sulfoxide were distilled off under reduced pressure. The reaction product including the salt of a side product and dimethyl sulfoxide was dissolved in 750 parts of methyl isobutyl ketone, 10 parts of 30% NaOH was added thereto, and the reaction was carried out at 70° C. for 1 hour. After the completion of the reaction, the reaction product was washed twice with 200 parts of water. After separating the oil from the water, methyl isobutyl ketone was recovered by distillation from the oil layer to obtain 370 parts of an epoxy resin (a-1) having an epoxy equivalent of 290 and a softening point of 62° C.

2,900 parts (10 equivalents) of the epoxy resin (a-1) obtained, 720 parts (10 equivalents) of acrylic acid, 2.8 parts of methyl hydroquinone and 1,950 parts of carbitol acetate were injected, and the mixture was heated to 90° C. and stirred to dissolve the reaction mixture. Subsequently, the reaction solution was cooled to 60° C., 16.7 parts of triphenylphosphine was injected thereto, and the mixture was heated to 100° C. and reacted for about 32 hours to obtain a reactant having an acid value of 1.0 mgKOH/g. Next, 786 parts (7.86 mol) of anhydrous succinic acid and 423 parts of carbitol acetate were injected thereto, the mixture was heated to 95° C., and reaction was performed for about 6 hours.

In this manner, a resin solution having a solid matter acid value of 100 mgKOH/g and a solid content of 65% was obtained. Hereinafter, this will be referred to as Varnish R-3.

(Preparation of Neuburg Siliceous Earth Particle Slurry)

### Preparation of Sillitin N85 Puriss Slurry

500 g of Sillitin N85 Puriss (manufactured by Hoffmann-Mineral GmbH), 500 g of carbitol acetate as a solvent and 15 g of N-phenyl-3-aminopropyltrimethoxysilane as a silane coupling agent were mixed and stirred, and dispersion treatment was performed by using zirconia beads having a size of 0.5 μm as a bead mill. This was repeated twice and the mixture was passed through a filter having a pore size of 3 μm to prepare Sillitin N85 Puriss slurry.

Preparation of Aktisil AM Slurry

500 g of Aktisil AM (manufactured by Hoffmann-Mineral GmbH), 500 g of carbitol acetate as a solvent and 15 g of N-phenyl-3-aminopropyltrimethoxysilane as a silane coupling agent were mixed and stirred, and dispersion treatment was performed by using zirconia beads having a size of 0.5 μm as a bead mill. This was repeated twice and the mixture was passed through a filter having a pore size of 3 μm to prepare Aktisil AM slurry.

Preparation of Aktisil MM Slurry

500 g of Aktisil MM (manufactured by Hoffmann-Mineral GmbH), 500 g of carbitol acetate as a solvent and 15 g of N-phenyl-3-aminopropyltrimethoxysilane as a silane coupling agent were mixed and stirred, and dispersion treatment was performed by using zirconia beads having a size of 0.5 μm as a bead mill. This was repeated twice and the mixture was passed through a filter having a pore size of 3 μm to prepare Aktisil MM slurry.

### Preparation of Photocurable Resin Compositions in Examples 1 to 11 and Comparative Examples 1 to 3

These resin solutions in the Synthetic Examples were used and blended at a ratio (parts by mass) shown in Table 1, pre-mixing was performed by a stirrer, and then the mixture was kneaded by three roll mills to prepare photocurable resin compositions. Herein, the degree of dispersion of the photocurable resin composition obtained was evaluated by particle size measurement by using a grind meter manufactured by Erichsen Co., and thus was 15 μm or less.

TABLE 1

| Composition | | Example | | | | | | | | | | | Comparative Example | | |
|---|---|---|---|---|---|---|---|---|---|---|---|---|---|---|---|
| (Parts by mass) | | 1 | 2 | 3 | 4 | 5 | 6 | 7 | 8 | 9 | 10 | 11 | 1 | 2 | 3 |
| Varnish | A-1 | 141 | 141 | 141 | 141 | 99 | 99 | 99 | 141 | 141 | 141 | | 141 | | |
| | A-2 | | | | | 60 | | | | | | | | | |
| | A-3 | | | | | | 56 | | | | | | | | |
| | R-1 | | | | | | | | | | | 108 | | 77 | |
| | R-2 | | | | | | | 46 | | | | | | 77 | |
| | R-3 | | | | | | | | | | | 46 | | | 154 |
| Photopolymer- | B-1 *¹ | | | | | | | | | | | 7.5 | | | 15 |
| ization | B-2 *² | | | | | | | | | | | | | | 1 |
| initiator | B-3 *³ | 1.5 | 1.5 | 1.5 | | | | | 1.5 | 1.5 | 1.5 | 1.5 | 1.5 | 1.5 | |
| | B-4 *⁴ | | | | 1.0 | 1.0 | 1.0 | 1.0 | | | | | | | |
| Thermosetting | E-1 *⁵ | 25 | 25 | 25 | 25 | 25 | 25 | 25 | 25 | 25 | 25 | 25 | 25 | 25 | 25 |
| component | E-2 *⁶ | 20 | 20 | 20 | 20 | 20 | 20 | 20 | 20 | 20 | 20 | 20 | 20 | 20 | 20 |
| Neuburg | *⁷ | 200 | | | | 40 | | | | | | | | | |
| siliceous | *⁸ | | 200 | 160 | 160 | 160 | 160 | 160 | | 500 | | | | | |
| earth particles | *⁹ | | | | | | | | 340 | | 160 | 160 | | | |
| Melamine | | 3.0 | 3.0 | 3.0 | 3.0 | 3.0 | 3.0 | 3.0 | 3.0 | 3.0 | 3.0 | 3.0 | 3.0 | 3.0 | 3.0 |
| Coloring agent | G-1 *¹⁰ | 0.3 | 0.3 | 0.3 | 0.3 | 0.3 | 0.3 | 0.3 | 0.3 | 0.3 | 0.3 | 0.3 | 0.3 | 0.3 | 0.3 |
| | G-2 *¹¹ | 0.8 | 0.8 | 0.8 | 0.8 | 0.8 | 0.8 | 0.8 | 0.8 | 0.8 | 0.8 | 0.8 | 0.8 | 0.8 | 0.8 |
| Antioxidant | *¹² | 0.1 | 0.1 | 0.1 | 0.1 | 0.1 | 0.1 | 0.1 | 0.1 | 0.1 | 0.1 | 0.1 | 0.1 | 0.1 | 0.1 |
| | *¹³ | 2 | 2 | 2 | 2 | 2 | 2 | 2 | 2 | 2 | 2 | 2 | 2 | 2 | 2 |
| Chain transfer | | 0.2 | 0.2 | 0.2 | 0.2 | 0.2 | 0.2 | 0.2 | 0.2 | 0.2 | 0.2 | 0.2 | 0.2 | 0.2 | 0.2 |
| agent *¹⁴ | | | | | | | | | | | | | | | |
| Filler | *¹⁵ | | 30 | | | | | | | | | | 180 | 25 | 120 |
| | *¹⁶ | | | | | 5 | 5 | 5 | 5 | 5 | 5 | 5 | | 160 | |
| | *¹⁷ | | | 30 | 30 | 20 | 30 | 30 | | | 30 | 30 | | 20 | 10 |
| Thixo agent *¹⁸ | | 5 | 5 | 5 | 5 | 5 | 5 | 5 | 5 | 5 | 5 | 5 | 5 | 5 | 5 |
| Silicone-based | | 3 | 3 | 3 | 3 | 3 | 3 | 3 | 3 | 3 | 3 | 3 | 3 | 3 | 3 |
| defoaming agent | | | | | | | | | | | | | | | |
| Silane coupling | | | | | | | | | 3 | 3 | | | 3 | 3 | 3 |
| agent *¹⁹ | | | | | | | | | | | | | | | |
| Organic solvent *²⁰ | | 5 | 5 | 5 | 5 | 5 | 5 | 5 | 5 | 5 | 5 | 5 | 5 | 5 | 5 |
| DPHA *²¹ | | 15 | 15 | 15 | 15 | 15 | 15 | 15 | 15 | 15 | 15 | 15 | 15 | 15 | 15 |
| Thermosetting | *²² | | | | | | 5 | | | | | | | | |
| component | *²³ | | | | | 5 | | | | | | | | | |

Remark
*¹ 2-methyl-1-(4-methylthio phenyl)-2-morpholino propan-1-one (IRGACURE 907: manufactured by Ciba Specialty Chemicals Inc.)
*² 2,4-diethylthioxanthone (KAYACURE DETX-S: manufactured by Nippon Kayaku Co., Ltd.)
*³ Ethanone, 1-[9-ethyl-6-(2-methylbenzoyl)-9H-carbazol-3-yl)-,1,1-(O-acetyloxime) (IRGACURE OXE02 manufactured by Ciba Specialty Chemicals Inc.)
*⁴ ADEKA ARKLS NCI-831: manufactured by ADEKA Corporation
*⁵ Biphenyl novolac type epoxy resin ((NC3000HCA75: manufactured by Nippon Kayaku Co., Ltd.)
*⁶ Bixylenol type epoxy resin (YX-4000: manufactured by Japan Epoxy Resin Co., Ltd.)
*⁷ Sillitin N85 Puriss Slurry
*⁸ Aktisil AM Slurry
*⁹ Aktisil MM Slurry
*¹⁰ C.I. Pigment Blue 15:3
*¹¹ C.I. Pigment Yellow 147
*¹² Phenothiazine
*¹³ IRGANOX1010: manufactured by Ciba Specialty Chemicals Inc.
*¹⁴ 2-mercapto benzothiazole (ACCEL (registered trademark)M: manufactured by Kawaguchi Chemical Industry Co., Ltd.)
*¹⁵ Barium sulfate (B-30: manufactured by Sakai Chemical Industry Co., Ltd.)
*¹⁶ Spherical silica (SO-E3: manufactured by Admatechs Co., Ltd.)
*¹⁷ Talc (SG-2000: manufactured by Nippon Talc Co., Ltd.)
*¹⁸ HYDROTALCITE (DHT-4A: manufactured by Kyowa Chemical Industry Co., Ltd.)
*¹⁹ KBM-573 (manufactured by Shin-Etsu Chemical Co., Ltd.)
*²⁰ Diethylene glycol monoethyl ether acetate
*²¹ Dipentaerythritol hexaacrylate
*²² Epoxidized polybutadiene (PB3600: manufactured by DAICEL CHEMICAL INDUSTRIES, LTD.)
*²³ Methylated melamine resin (Mw-100LM: manufactured by Sanwa Chemical Co., Ltd.)

Evaluation of Characteristics of Coating Film:

<Optimum Exposure Amount>

A circuit pattern board with a copper thickness of 18 μm was subjected to a copper surface roughening treatment (MECetchBOND (registered trademark) CZ-8100 manufactured by MEC COMPANY LTD.), washed with water and dried. And then, each of the photocurable resin compositions in Examples 1 to 11 and Comparative Examples 1-3 was applied onto the entire surface of a substrate by using a roll coater to have a dry film thickness of about 20 μm, and the coating film on the substrate was dried at 80° C. in a hot air circulating drying oven for 60 minutes.

After drying, the coating film was exposed to light through a step tablet (KODAK No. 2) by using an exposure apparatus equipped with high-pressure mercury lamps. Development (30° C., 0.2 MPa, and 1 wt % aqueous solution of sodium carbonate) was performed for 60 seconds, and when the pattern of the step tablet remaining was at step seven, the exposure amount was rated as the optimum exposure amount.

<Maximum Developable Life>

Each of the photocurable resin compositions in Examples 1 to 11 and Comparative Examples 1 to 3 was applied onto the entire surface of a copper foil substrate on which patterns are formed by using a roll coater to have a dry film thickness of about 20 μm, and dried at 80° C. Then, each of the substrates was taken out every 10 minutes from 20 minutes to 80 minutes, and left to cool to room temperature.

On each of these substrates having been dried for different periods of time, development was performed by a 1 wt % aqueous solution of sodium carbonate of 30° C. for 60 seconds under condition of a spraying pressure of 0.2 MPa, and the maximally permissible drying time in which any residue does not remain on the substrate was rated as the maximum developable life.

Evaluation of Characteristics of Cured Article:

Each of the photocurable resin compositions in the Examples and Comparative Examples was applied onto the entire surface of a copper foil substrate on which patterns are formed by using a roll coater to have a dry film thickness of about 20 μm, and the coating film on the substrate was dried at 80° C. for 30 minutes and left to cool to room temperature. On the substrate, a pattern was exposed at an optimum exposure amount by using an exposure apparatus equipped with high-pressure mercury lamps, and then development was performed by a 1 wt % aqueous solution of sodium carbonate of 30° C. for 90 seconds under condition of a spraying pressure of 0.2 MPa to obtain a pattern.

The substrate was cured by being subjected to UV light irradiation under the conditions of accumulated exposure amount of 1,000 mJ/cm² in a UV conveyor furnace and then heating at 150° C. for 60 minutes, and an evaluation substrate on which a pattern of a cured article was formed was obtained.

By using the evaluation substrate obtained, acid resistance, alkali resistance, resistance to soldering heat, resistance to electroless gold plating and PCT resistance were evaluated as follows. Further, an evaluation substrate was prepared likewise, and thermal impact resistance, HAST resistance, CTE measurement and resolution properties were evaluated as follows.

<Acid Resistance>

The evaluation substrate was immersed in a 10 vol % H₂SO₄ aqueous solution at room temperature for 30 minutes, the diffusion or elution of the coating film was visually confirmed, and peeling-off was also confirmed by a tape peeling. The criteria for evaluation are as follows.
O: Change not acknowledged
Δ: Very slightly changed
x: Occurrence of expansion or swelling dropout of coating film

<Alkali Resistance>

The evaluation substrate was immersed in a 10 vol % NaOH aqueous solution at room temperature for 30 minutes, the diffusion or elution of the coating film was visually confirmed, and peeling-off was also confirmed by a tape peeling. The criteria for evaluation are as follows.
O: Change not acknowledged
Δ: Very slightly changed
x: Occurrence of expansion or swelling dropout of coating film

<Solder Heat Resistance>

The evaluation substrate was applied with a rosin-based flux, and then was immersed in a solder bath previously set at 260° C. Then, the flux was washed with a modified alcohol, and the expansion and peeling-off of the resist layer were visually evaluated. The criteria for evaluation are as follows.
O: Peeling-off not acknowledged even when the immersion for 10 seconds is repeated three times or more.
Δ: Slightly peeled off when the immersion for 10 seconds is repeated three times or more
x: Expansion and peeling-off of the resist layer found when the immersion for 10 seconds is repeated three times or less

<Resistance to Electroless Gold Plating>

An electroless nickel plating bath and an electroless gold plating bath, both available in the market, were used on the evaluation substrate, and plating was performed under the conditions of 5 μm of nickel and 0.05 μm of gold. In the plated evaluation substrate, it was evaluated whether the resist layer was peeled off or infiltrated by plating by a tape peeling, and then it was evaluated whether the resist layer was peeled off by a tape peeling. The criteria for evaluation are as follows.
O: Infiltration not observed after plating and no peeling-off after tape peeling
Δ: Whitening confirmed after plating, but no peeling-off after tape peeling
x: Slight infiltration confirmed after plating and peeling-off also observed after tape peeling

<PCT Resistance>

The evaluation substrate which had been subjected to the electroless gold plating treatment in the same manner as the evaluation for resistance to electroless gold plating was treated under the conditions of 121° C., saturation, and 0.2 MPa for 168 hours by using a PCT apparatus (HAST SYSTEM TPC-412MD manufactured by ESPEC Corp.), and the state of the coating film was examined to evaluate the PCT resistance. The criteria for evaluation are as follows.
O: No expansion, peeling-off, discoloration and elution
Δ: Slight expansion, peeling-off, discoloration and elution
x: A lot of expansion, peeling-off, discoloration and elution

<Thermal Impact Resistance>

In the same manner as above, as the rate of from −55° C./30 minutes to 150° C./30 minutes was set as a cycle, a thermal impact resistance evaluation substrate obtained by forming a pattern of a cured article of square exclusion and circle exclusion was subjected to a resistance test under the conditions of 1,000 cycles by a thermal impact tester (manufactured by ETAC Engineering Co., Ltd.).

After completion of the test, the pattern of the cured article which had been subjected to the treatment was visually observed and it was evaluated whether or not the cracks occurred. The criteria for evaluation are as follows.
O: The rate of occurrence of cracks less than 30%
Δ: The rate of occurrence of cracks from 30% to 50%
x: The rate of occurrence of cracks more than 50%

<HAST Resistance>

A pattern of a cured article of a photocurable resin composition was formed in the same manner as above on a BT substrate having a comb type electrode (line/space=30 μm/30 μm) formed therein, and a substrate for evaluation of HAST resistance was prepared. The evaluation substrate was placed in a high-temperature and high-humidity chamber kept under the atmosphere of 130° C. and a humidity of 85%, a voltage of 12 V was applied to the electrode, and a HAST test was performed for 168 hours in the chamber.

The value of insulation resistance in the chamber after a lapse of 168 hours was measured, and the HAST resistance was evaluated. The criteria for evaluation are as follows.
O: 10⁸Ω or more
Δ: From 10⁶Ω to 10⁸Ω
x: 10⁶Ω or less

<CTE Measurement>

A cured article of a photocurable resin composition having a thickness of about 40 μm was formed and a coefficient of thermal expansion (CTE) was measured by TMA (TMA/SS 6100 manufactured by SII NanoTechnology Inc.). In the measurement, in order to rule out the influences of curing, contraction and the like, an anneal treatment was performed at 1st Run and CTE was calculated from the measurement at 2nd Run. In addition, the value of CTE measured was determined as an average value at from 30° C. to 80° C.

<Evaluation of Resolution Properties>

A pattern of a cured article of the photocurable resin composition, which had an aperture of 100 μm, was formed on a substrate and observed by scanning electron microscope (SEM). By measuring the diameter of the aperture obtained, evaluation was performed by a change rate of resolution properties for the negative value. The criteria for evaluation are as follows.
O: Reduction rate of aperture diameter less than 15%
x: Reduction rate of aperture diameter 15% or more

TABLE 2

| | Example | | | | | | | | | | | Comparative Example | | |
|---|---|---|---|---|---|---|---|---|---|---|---|---|---|---|
| Characteristics | 1 | 2 | 3 | 4 | 5 | 6 | 7 | 8 | 9 | 10 | 11 | 1 | 2 | 3 |
| Optimum exposure | 200 | 200 | 200 | 150 | 130 | 130 | 150 | 150 | 100 | 200 | 200 | 200 | 150 | 350 |
| amount (mJ/cm²) | | | | | | | | | | | | | | |
| Maximum developable | 60 | 60 | 60 | 60 | 60 | 60 | 60 | 60 | 60 | 60 | 50 | 60 | 60 | 40 |
| life (min) | | | | | | | | | | | | | | |
| Acid resistance | ◯ | ◯ | ◯ | ◯ | ◯ | ◯ | ◯ | ◯ | ◯ | ◯ | ◯ | ◯ | ◯ | ◯ |
| Alkali resistance | ◯ | ◯ | ◯ | ◯ | ◯ | ◯ | ◯ | ◯ | ◯ | ◯ | ◯ | ◯ | ◯ | ◯ |
| Solder heat | ◯ | ◯ | ◯ | ◯ | ◯ | ◯ | ◯ | ◯ | ◯ | ◯ | ◯ | ◯ | ◯ | ◯ |
| resistance | | | | | | | | | | | | | | |
| Resistance to | ◯ | ◯ | ◯ | ◯ | Δ | ◯ | ◯ | ◯ | ◯ | ◯ | ◯ | ◯ | Δ | Δ |
| electroless gold | | | | | | | | | | | | | | |
| plating | | | | | | | | | | | | | | |
| PCT resistance | ◯ | ◯ | ◯ | ◯ | ◯ | Δ | Δ | ◯ | ◯ | ◯ | Δ | ◯ | X | X |
| Thermal impact | ◯ | ◯ | ◯ | ◯ | ◯ | ◯ | ◯ | ◯ | ◯ | ◯ | ◯ | X | ◯ | Δ |
| resistance | | | | | | | | | | | | | | |
| HAST resistance | ◯ | ◯ | ◯ | ◯ | ◯ | ◯ | ◯ | ◯ | ◯ | ◯ | Δ | ◯ | X | X |
| CTE (×10⁻⁶) ° C. | 47 | 46 | 41 | 42 | 42 | 40 | 40 | 35 | 30 | 41 | 43 | 56 | 45 | 54 |
| Resolution properties | ◯ | ◯ | ◯ | ◯ | ◯ | ◯ | ◯ | ◯ | ◯ | ◯ | ◯ | ◯ | X | ◯ |

### Examples 12 to 22 and Comparative Examples 4 to

Each of the photocurable resin compositions in Examples 1 to 11 and Comparative Examples 1 to 3, which had been prepared at the blending ratios shown in Table 1, was diluted with methyl ethyl ketone, and the solution was applied on a PET film. This was dried at 80° C. for 30 minutes, a dried coating film having a thickness of 20 μm was formed, and a cover film was bonded thereon to manufacture a dry film, and each was taken as the Examples 12 to 22 and Comparative Examples 4 to 6.

For the dry film obtained, evaluation was performed as follows.

<Evaluation of Dry Film>

A cover film was peeled off from the dry film obtained, and the dry film was heat-laminated on a pattern-formed copper foil substrate. Subsequently, pattern exposure was performed at an optimum exposure amount on the substrate by using an exposure apparatus equipped with high-pressure mercury lamps.

After exposure, a carrier film was peeled off, development was performed by a 1 wt % aqueous solution of sodium carbonate of 30° C. for 90 seconds under condition of a spraying pressure of 0.2 MPa, and a pattern was obtained. The substrate was cured by being subjected to UV light irradiation under the conditions of accumulated exposure amount of 1,000 mJ/cm² in a UV conveyor furnace and then heating at 150° C. for 60 minutes, and an evaluation substrate on which a pattern of a cured article was formed was obtained.

On the evaluation substrate obtained, each of characteristics was evaluated in the same manner as in the evaluations in Examples 1 to 11 and Comparative Examples 1 to 3. The results are shown in Table 3.

TABLE 3

| | Example | | | | | | | | | | | Comparative Example | | |
|---|---|---|---|---|---|---|---|---|---|---|---|---|---|---|
| Characteristics | 12 | 13 | 14 | 15 | 16 | 17 | 18 | 19 | 20 | 21 | 22 | 4 | 5 | 6 |
| Optimum exposure | 200 | 200 | 200 | 150 | 130 | 130 | 150 | 150 | 100 | 200 | 200 | 200 | 150 | 350 |
| amount (mJ/cm²) | | | | | | | | | | | | | | |
| Acid resistance | ◯ | ◯ | ◯ | ◯ | ◯ | ◯ | ◯ | ◯ | ◯ | ◯ | ◯ | ◯ | ◯ | ◯ |
| Alkali resistance | ◯ | ◯ | ◯ | ◯ | ◯ | ◯ | ◯ | ◯ | ◯ | ◯ | ◯ | ◯ | ◯ | ◯ |
| Solder heat | ◯ | ◯ | ◯ | ◯ | ◯ | ◯ | ◯ | ◯ | ◯ | ◯ | ◯ | ◯ | ◯ | ◯ |
| resistance | | | | | | | | | | | | | | |
| Resistance to | ◯ | ◯ | ◯ | ◯ | Δ | ◯ | ◯ | ◯ | ◯ | ◯ | ◯ | ◯ | Δ | Δ |
| electroless gold | | | | | | | | | | | | | | |
| plating | | | | | | | | | | | | | | |
| PCT resistance | ◯ | ◯ | ◯ | ◯ | ◯ | Δ | Δ | ◯ | ◯ | ◯ | Δ | ◯ | X | X |
| Thermal impact | ◯ | ◯ | ◯ | ◯ | ◯ | ◯ | ◯ | ◯ | ◯ | ◯ | ◯ | X | ◯ | Δ |
| resistance | | | | | | | | | | | | | | |
| HAST resistance | ◯ | ◯ | ◯ | ◯ | ◯ | ◯ | ◯ | ◯ | ◯ | ◯ | Δ | ◯ | X | X |
| CTE (×10⁻⁶) ° C. | 47 | 46 | 41 | 42 | 42 | 40 | 40 | 35 | 30 | 41 | 43 | 56 | 45 | 54 |
| Resolution properties | ◯ | ◯ | ◯ | ◯ | ◯ | ◯ | ◯ | ◯ | ◯ | ◯ | ◯ | ◯ | X | ◯ |

From the results shown in Tables 2 and 3, it can be known that the photocurable resin composition of the exemplary embodiment and the dry film thereof have excellent coating film characteristics and the cured article thereof has, for example, PCT resistance, thermal impact resistance, and HAST resistance required for a solder resist for a semiconductor package and excellent cured article physical properties and resolution properties.

1. A photocurable resin composition, comprising:
a carboxyl group-comprising resin;
a photopolymerization initiator; and
Neuburg siliceous earth particles.

2. The photocurable resin composition of claim 1, wherein the Neuburg siliceous earth particles are surface-treated.

3. The photocurable resin composition of claim 1, further comprising:
a silane coupling agent.

4. A dry film, comprising:
a dried coating film obtained by applying the photocurable resin composition of claim 1 on a film and drying the composition.

5. A cured article obtained by a process comprising:
applying the photocurable resin composition of claim 1 on a substrate and drying the composition.

6. A printed wiring board comprising the cured article of claim 5.

7. The photocurable resin composition of claim 2, further comprising:
a silane coupling agent.

8. A dry film, comprising:
a dried coating film obtained by applying the photocurable resin composition of claim 7 on a film and drying the composition.

9. A cured article obtained by a process comprising:
applying the photocurable resin composition of claim 7 on a substrate and drying the composition.

10. A printed wiring board comprising the cured article of claim 9.

11. A cured article obtained by a process comprising:
curing a dried coating film formed on a substrate by attaching the dry film of claim 4 onto the substrate by irradiation with active energy ray.

12. A printed wiring board comprising the cured article of claim 11.

13. A cured article obtained by a process comprising:
curing a dried coating film formed on a substrate by attaching the dry film of claim 8 onto the substrate by irradiation with active energy ray.

14. A printed wiring board comprising the cured article of claim 13.
